(19) United States
(12) Patent Application Publication
(10) Pub. No.: US 2006/0287833 A1
(43) Pub. Date: Dec. 21, 2006

(54) Method and system for sequencing nucleic acid molecules using sequencing by hybridization and comparison with decoration patterns

(76) Inventor: Zohar Yakhini, Petah Tiqva (IL)

Correspondence Address: AGILENT TECHNOLOGIES INC., INTELLECTUAL PROPERTY ADMINISTRATION, M/S DU404, P.O. BOX 7599, LOVELAND, CO, 80537-0599, US

(21) Appl. No.: 11/156,136

(22) Filed: Jun. 17, 2005

(51) Int. Cl. G06F 19/00

(52) U.S. Cl. 702/20; 977/924

(57) ABSTRACT

Various embodiments of the present invention are directed to methods and systems for sequencing a target molecule. In one embodiment of the present invention, a spectrum of the target molecule is determined. A decoration pattern of the target molecule is determined using physical methods. One or more candidate molecule sequences are determined based on having nucleic acid sequences that are consistent with the spectrum and the decoration pattern of the target molecule.

Embodiments of the present invention relate to the field of sequencing nucleic acid molecules, and, in particular, to a method for determining the base sequence of an unknown or partially sequenced nucleic acid molecule based on observed decoration patterns.

### BACKGROUND OF THE INVENTION

The present invention is related to microarrays. In order to facilitate discussion of the present invention, a general background for particular kinds of microarrays is provided below. In the following discussion, the terms “microarray,” “molecular array,” and “array” are used interchangeably. The terms “microarray” and “molecular array” are well known and well understood in the scientific community. As discussed below, a microarray is a precisely manufactured tool which may be used in design, diagnostic testing, or various other analytical techniques to analyze complex solutions of any type of molecule that can be optically or radiometrically detected and that can bind with high specificity to complementary molecules synthesized within, or bound to, discrete features on the surface of a microarray. Because microarrays are widely used for analysis of nucleic acid samples, the following background information on microarrays is introduced in the context of analysis of nucleic acid solutions following a brief background of nucleic acid chemistry.

Deoxyribonucleic acid (“DNA”) and ribonucleic acid (“RNA”) are linear polymers, each synthesized from four different types of subunit molecules. FIG. 1 illustrates a short DNA polymer 100, called an oligomer, composed of the following subunits: (1) deoxy-adenosine 102; (2) deoxy-thymidine 104; (3) deoxy-cytosine 106; and (4) deoxy-guanosine 108. Phosphorylated subunits of DNA and RNA molecules, called “nucleotides,” are linked together through phosphodiester bonds 110-115 to form DNA and RNA polymers. A linear DNA molecule, such as the oligomer shown in FIG. 1, has a 5′ end 118 and a 3′ end 120. A DNA polymer can be chemically characterized by writing, in sequence from the 5′ end to the 3′ end, the single letter abbreviations A, T, C, and G for the nucleotide subunits that together compose the DNA polymer. For example, the oligomer 100 shown in FIG. 1 can be chemically represented as “ATCG.”

The DNA polymers that contain the organization information for living organisms occur in the nuclei of cells in pairs, forming double-stranded DNA helices. One polymer of the pair is laid out in a 5′ to 3′ direction, and the other polymer of the pair is laid out in a 3′ to 5′ direction, or, in other words, the two strands are anti-parallel. The two DNA polymers, or strands, within a double-stranded DNA helix are bound to each other through attractive forces including hydrophobic interactions between stacked purine and pyrimidine bases and hydrogen bonding between purine and pyrimidine bases, the attractive forces emphasized by conformational constraints of DNA polymers. FIGS. 2A-B illustrates the hydrogen bonding between the purine and pyrimidine bases of two anti-parallel DNA strands. AT and GC base pairs, illustrated in FIGS. 2A-B, are known as Watson-Crick (“WC”) base pairs. Two DNA strands linked together by hydrogen bonds forms the familiar helix structure of a double-stranded DNA helix. FIG. 3 illustrates a short section of a DNA double helix 300 comprising a first strand 302 and a second, anti-parallel strand 304.

Double-stranded DNA may be denatured, or converted into single stranded DNA, by changing the ionic strength of the solution containing the double-stranded DNA or by raising the temperature of the solution. Single-stranded DNA polymers may be renatured, or converted back into DNA duplexes, by reversing the denaturing conditions, for example by lowering the temperature of the solution containing complementary single-stranded DNA polymers. During renaturing or hybridization, complementary bases of anti-parallel DNA strands form WC base pairs in a cooperative fashion, leading to reannealing of the DNA duplex.

FIGS. 4-7 illustrate the principle of microarray-based hybridization assays. A microarray (402 in FIG. 4) comprises a substrate upon which a regular pattern of features is prepared by various manufacturing processes. The microarray 402 in FIG. 4, and in subsequent FIGS. 5-7, has a grid-like 2-dimensional pattern of square features, such as feature 404 shown in the upper left-hand corner of the microarray. Each feature of the microarray contains a large number of identical oligonucleotides covalently bound to the surface of the feature. These bound oligonucleotides are known as probes. In general, chemically distinct probes are bound to the different features of a microarray, so that each feature corresponds to a particular nucleotide sequence.

Once a microarray has been prepared, the microarray may be exposed to a sample solution of target DNA or RNA molecules (410-413 in FIG. 4) labeled with fluorophores, chemiluminescent compounds, or radioactive atoms 415-418. Labeled target DNA or RNA hybridizes through base pairing interactions to the complementary probe DNA, synthesized on the surface of the microarray. FIG. 5 shows a number of such target molecules 502-504 hybridized to complementary probes 505-507, which are in turn bound to the surface of the microarray 402. Targets, such as labeled DNA molecules 508 and 509, that do not contain nucleotide sequences complementary to any of the probes bound to the microarray surface do not hybridize to generate stable duplexes and, as a result, tend to remain in solution. The sample solution is then rinsed from the surface of the microarray, washing away any unbound-labeled DNA molecules. In other embodiments, unlabeled target sample is allowed to hybridize with the microarray first. Typically, such a target sample has been modified with a chemical moiety that will react with a second chemical moiety in subsequent steps. Then, either before or after a wash step, a solution containing the second chemical moiety bound to a label is reacted with the target on the microarray. After washing, the microarray is ready for analysis. Biotin and avidin represent an example of a pair of chemical moieties that can be utilized for such steps.

Finally, as shown in FIG. 6, the bound labeled DNA molecules are detected via optical or radiometric reading. Optical reading involves exciting labels of bound labeled DNA molecules with electromagnetic radiation of appropriate frequency and detecting fluorescent emissions from the labels, or detecting light emitted from chemiluminescent labels. When radioisotope labels are employed, radiometric reading can be used to detect the signal emitted from the hybridized features. Additional types of signals are also possible, including electrical signals generated by electrical properties of bound target molecules, magnetic properties of bound target molecules, and other such physical properties of bound target molecules that can produce a detectable signal. Optical, radiometric, or other types of reading produce an analog or digital representation of the microarray as shown in FIG. 7, with features to which labeled target molecules are hybridized similar to 702 optically or digitally differentiated from those features to which no labeled DNA molecules are bound. Features displaying positive signals in the analog or digital representation indicate the presence of DNA molecules with complementary nucleotide sequences in the original sample solution. Moreover, the signal intensity produced by a feature is generally related to the amount of labeled DNA bound to the feature, in turn related to the concentration, in the sample to which the microarray was exposed, of labeled DNA complementary to the oligonucleotide within the feature.

Sequencing by hybridization (“SBH”) is a well-known method that employs microarray-based hybridization assays to determine the sequence of a nucleic acid molecules having an unknown or partially known sequence (see e.g., Pevzner P. A. (1989) L-tuple DNA sequencing: computer analysis. J. Biomol. Struct. Dyn., 7, 63-74; and Pevsner P. A., Lysov Y., Khrapko K. R., Belyavsky A. (1991) Floreny'ev, Mirzabekov A. Improved Chips for Sequencing by Hybridization. J. Biomol. Struct. Dyn., 9(2), pp 399-410). The nucleic acid molecule having an unknown or partially known sequence is called a target molecule. The microarray-based hybridization assay uses all possible oligonucleotide probes of length k bases to determine all length k nucleic acid subsequences of the target molecule. A length k nucleic acid molecule is called a k-mer. A solution of labeled target molecules all of the same base sequence is applied to the microarray. The microarray-based hybridization assay produces a list of all k-mer subsequences found at least once in the target molecule. This list of all k-mers is called the spectrum of the target molecule.

The spectrum, however, does not reveal the location of any k-mer in the target molecule, nor does the spectrum count the number of times a k-mer sequence occurs in the target molecule. The spectrum of the target molecule and the target molecule length, denoted by n, can be used to construct a set, denoted by S, of all n-long nucleic acid molecules, called candidate molecules, that each have a known nucleic acid sequence and a spectrum identical to the target molecule. One of the candidate molecules has a nucleic acid sequence identical to the target molecule. Unfortunately, the number of candidate molecules in S increases exponentially with the target molecule length. The probability that S is composed of the unique reconstructed sequence of the target molecule having an unknown or partially known sequence alone is denoted P_{success} and is called the success probability. FIG. 8 is a plot of P_{success} versus the target molecule length n and for k equal to 8 (See S. Sagi, E. Yeger-Lotem, B. Chor, Z. Yakhini, “Using Restriction Enzymes to Improve Sequencing by Hybridization,” www.cs.technion.ac.il/users/wwwb/cgi-bin/tr-info.cgi?2002/CS/CS-2002-14). In FIG. 8, horizontal axis 801 corresponds to the length n, and vertical axis 802 corresponds to P_{success} Curve 803 identifies P_{success} as a function of the target molecule length n. The data points used to construct curve 803 are determined by simulating over at least 100 different target molecules for fixed values of n and k. The length n begins with the value “100” and is increased in quanta of 50, and k is assigned the value “8.” Curve 803 reveals that P_{success} decreases exponentially as n increases. For example, point 804 indicates that there is a better than 90% chance of uniquely reconstructing the sequence of a target molecule of length less than 200 bases using SBH alone with an 8-mer spectrum. However, point 804 indicates that there is less than a 5% chance of uniquely reconstructing the sequence of a target molecule of length 900 bases using SBH alone with an 8-mer spectrum. Moreover, for a target molecule of length 900, the corresponding set S may contain as many as 35,000 candidate molecules having an identical spectrum. Note that employing microarrays with longer probe lengths, such as 11-mer oligonucleotide probes improves P_{success} but this improvement will not be sufficient for competing with other sequencing methods.

Employing the SBH method alone to sequence target molecules is limited by the loss of unique reconstructability of target molecules having lengths in excess of about 200 bases. Moreover, chemical processes used to determine the spectrum of a target molecule and errors in reading the microarray image may contribute to reducing the reliability of using SBH alone to sequence a nucleic acid molecule. Lastly, the computational complexity associated with SBH methods tend to overwhelm data analysis for all but the simplest and shortest sequences. Therefore, sequencing tool manufacturers, designers, and diagnosticians have recognized the need for sequencing methods and systems that can reconstruct a nucleic acid sequence, or at least provide a small number of consistent nucleic acid sequences, for non-trivial target molecules in computationally reasonable time frames.

### SUMMARY OF THE INVENTION

Various embodiments of the present invention are directed to methods and systems for sequencing a target molecule. In one embodiment of the present invention, a spectrum of the target molecule is determined. A decoration pattern of the target molecule is determined using physical methods. One or more candidate molecule sequences are determined based on having nucleic acid sequences that are consistent with the spectrum and the decoration pattern of the target molecule.

### BRIEF DESCRIPTION OF THE DRAWINGS

FIG. 1 illustrates a short DNA polymer.

FIGS. 2A-B illustrates hydrogen bonding between the purine and pyrimidine bases of two anti-parallel DNA strands.

FIG. 3 illustrates a short section of a DNA double helix comprising a first strand and a second, anti-parallel strand.

FIG. 4 illustrates a microarray having 64 features.

FIG. 5 shows a number of target molecules hybridized to complementary probes, which are in turn bound to the surface of the microarray.

FIG. 6 illustrates the bound labeled DNA molecules detected via optical or radiometric reading.

FIG. 7 illustrates optical, radiometric, or other types of reading produced by an analog or digital representation of the microarray.

FIG. 8 is a plot of P_{success} as a function of target molecule length n.

FIG. 9 shows a spectrum associated with a hypothetical target molecule.

FIG. 10 illustrates part of a rank 3 de Bruijn directed graph.

FIG. 11 illustrates a full directed de Bruijn graph G(σ₄(s)).

FIG. 12 illustrates a directed tree that displays all the paths in the directed de Bruijn graph G(σ₄(s)), shown in FIG. 11.

FIG. 13 shows the paths remaining after the branches leading to SBH inconsistent paths in the directed tree of FIG. 12 have been pruned.

FIG. 14 shows candidate molecule nucleic acid sequences.

FIGS. 15A-B illustrates a nanopore aperture located in a barrier separating two volumes.

FIGS. 16A-D illustrate the use of nanopore technology and oligonucleotides probes to determine the presence of nucleic acid subsequences in a single-strand of DNA.

FIG. 17A-B illustrates current-based image decoration patterns and the error associated event resolution.

FIG. 18 shows the de Bruijn directed graph G (σ₄(s)), shown in FIG. 11, with SBH-fragments idenfied.

FIG. 19 illustrates a directed graph of the SBH-fragments identified in FIG. 18.

FIG. 20 shows two oligonucleotide probes of different lengths employed to identify decoration patterns of a hypothetical target molecule.

FIG. 21 illustrates two hypothetical high-resolution, current-based image decoration patterns.

FIG. 22 illustrates a root portion of a directed tree and expansion of a first node.

FIG. 23 illustrates concatenating SBH-fragments.

FIG. 24 shows candidate molecule nucleic acid sequences.

FIG. 25 illustrates pruning the directed tree shown in FIG. 22.

FIG. 26 illustrates expanding a node of the graph, shown in FIG. 25, by adding edges which coincide with edges of the graph shown in FIG. 19.

FIG. 27 illustrates expanding a node of the graph, shown in FIG. 26, by adding edges which coincide with edges of the graph shown in FIG. 19.

FIG. 28 shows two candidate molecule nucleic acid sequences.

FIG. 29 illustrates expanding a node, shown in FIG. 27, by adding edges which coincide with edges of the graph shown in FIG. 19.

FIG. 30 is a control-flow diagram that describes the method “Sequencing Nucleic Acid Molecules” according to one embodiment of the present invention.

FIG. 31 is a control-flow diagram of the routine “Dynamic Tree Pruning.”

FIG. 32 is control-flow diagram of the routine “Check SBH.”

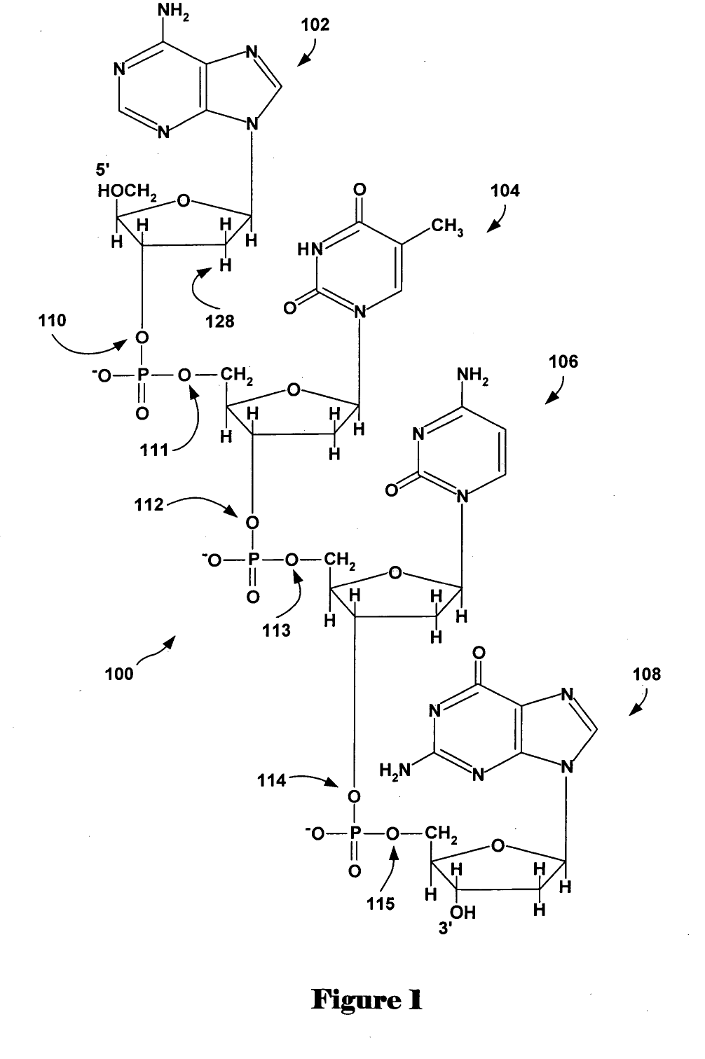

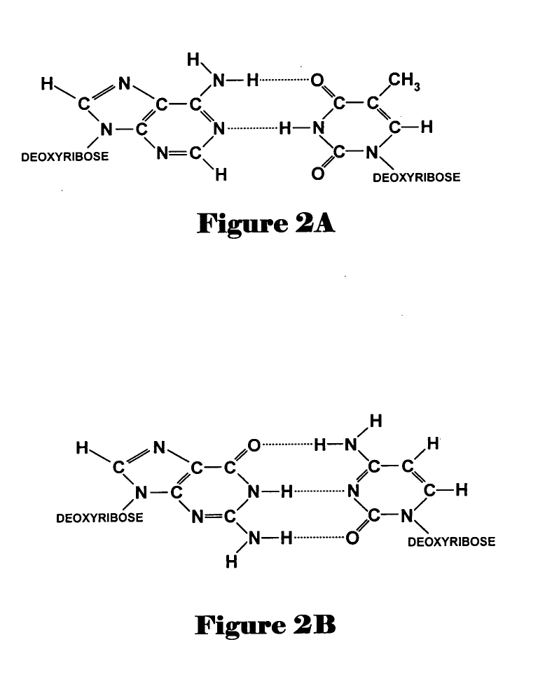

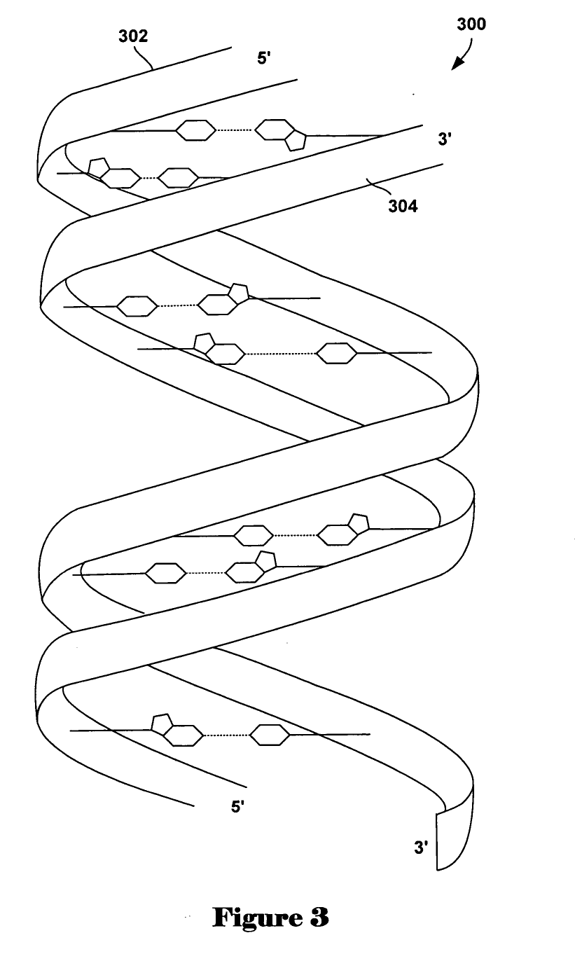

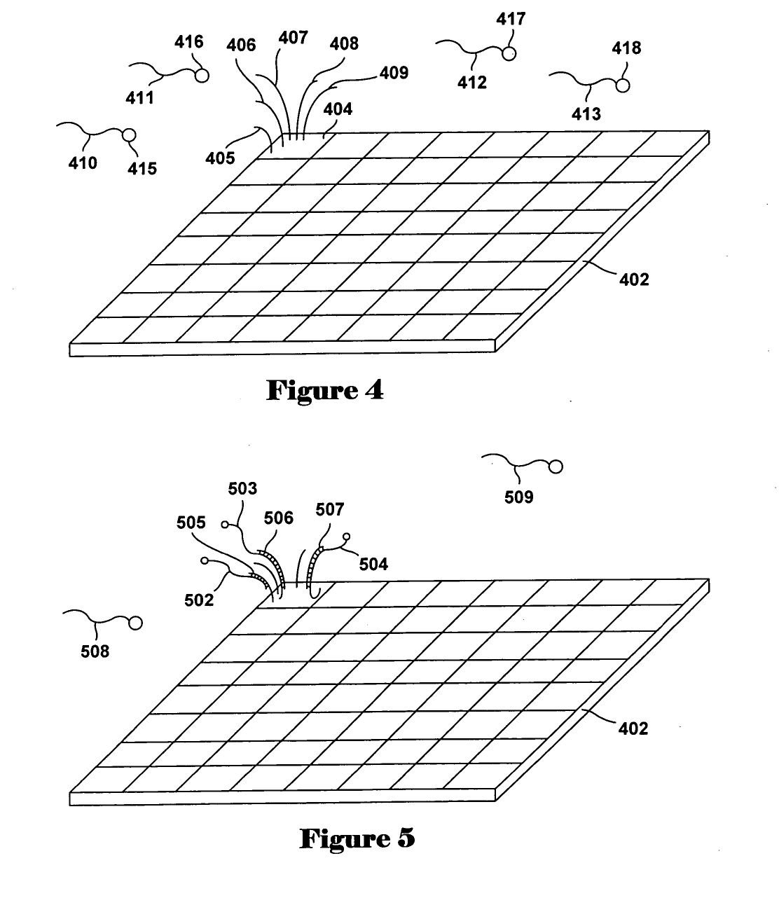

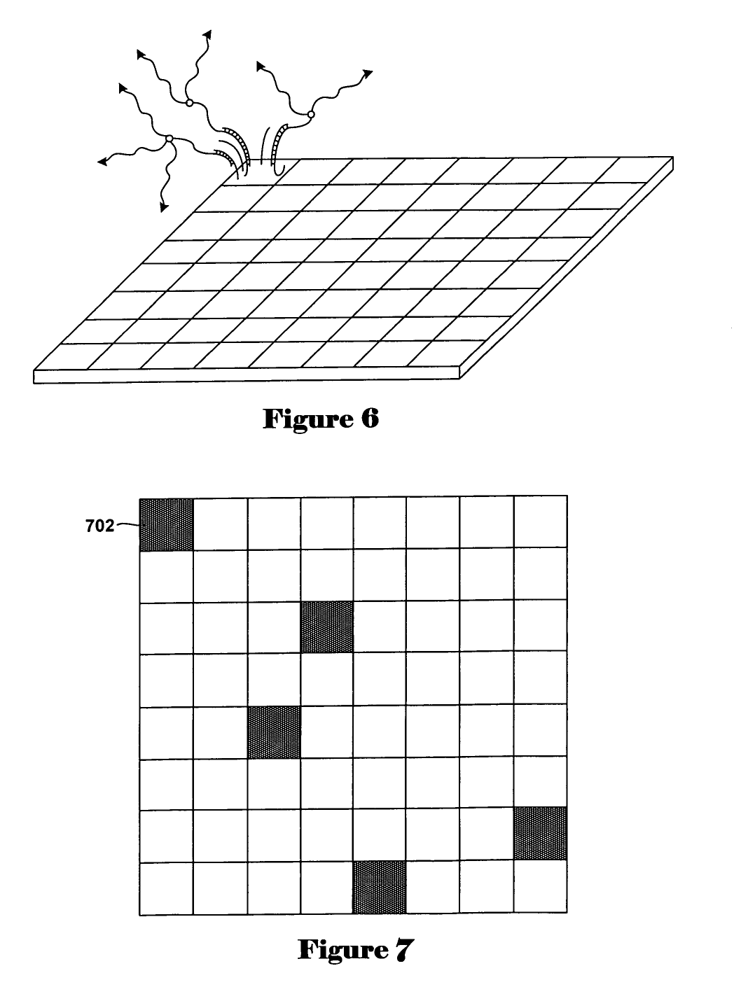

### DETAILED DESCRIPTION OF EMBODIMENTS OF THE INVENTION

Various embodiments of the present invention are directed to methods and systems for sequencing a target molecule. The methods of the present invention reconstruct the unique nucleic acid sequence of the target molecule, or at least provide a small number of nucleic acid molecules having nucleic acid sequences consistent with the target molecule, by combining information obtained from the SBH spectrum of the target molecule with information regarding the pattern and approximate location of certain subsequences of the target molecule to dynamically generate and eliminate candidate molecules having known nucleic acid sequences. In one embodiment of the present invention, described below, a directed tree is generated and simultaneously pruned by discarding branches that correspond to candidate molecule sequences that are neither SBH consistent nor consistent with the pattern and location of nucleic acid subsequences of the target molecule. At least one of the one or more candidate molecules have nucleic acid sequences that are consistent with the nucleic acid sequence of the target molecule. Additional information, such as nucleic acid sequences that are homologous to the target molecule, can be employed to further reduce the number of candidate molecules.

The following discussion includes four subsections, a first subsection including additional information about microarrays, a second subsection including additional information about the SBH method, a third subsection that describes determining the decoration pattern of a target molecule using nanopore based methods, and a final subsection that describes embodiments of the present invention.

### Additional Information about Microarrays

A microarray may include any one-dimensional, two-dimensional, or three-dimensional arrangement of addressable regions, or features, each bearing a particular chemical moiety or moieties, such as biopolymers, associated with that region. Any given microarray substrate may carry one, two, or four or more microarrays disposed on a front surface of the substrate. Depending upon the use, any or all of the microarrays may be the same or different from one another and each may contain multiple spots or features. A typical microarray may contain more than ten, more than one hundred, more than one thousand, more ten thousand features, or even more than one hundred thousand features, in an area of less than 10 cm² or even less than 5 cm². For example, square features may have widths, or round feature may have diameters, in the range from a 10 μm to 1.0 cm. In other embodiments each feature may have a width or diameter in the range of 1.0 μm to 1.0 mm, usually 5.0 μm to 500 μm, and more usually 10 μm to 200 μm. Features other than round or square may have area ranges equivalent to that of circular features with the foregoing diameter ranges. At least some, or all, of the features may be of different compositions (for example, when any repeats of each feature composition are excluded the remaining features may account for at least 5%, 10%, or 20% of the total number of features). Inter-feature areas are typically, but not necessarily, present. Inter-feature areas generally do not carry probe molecules. Such inter-feature areas typically are present where the microarrays are formed by processes involving drop deposition of reagents, but may not be present when, for example, photolithographic microarray fabrication processes are used. When present, interfeature areas can be of various sizes and configurations.

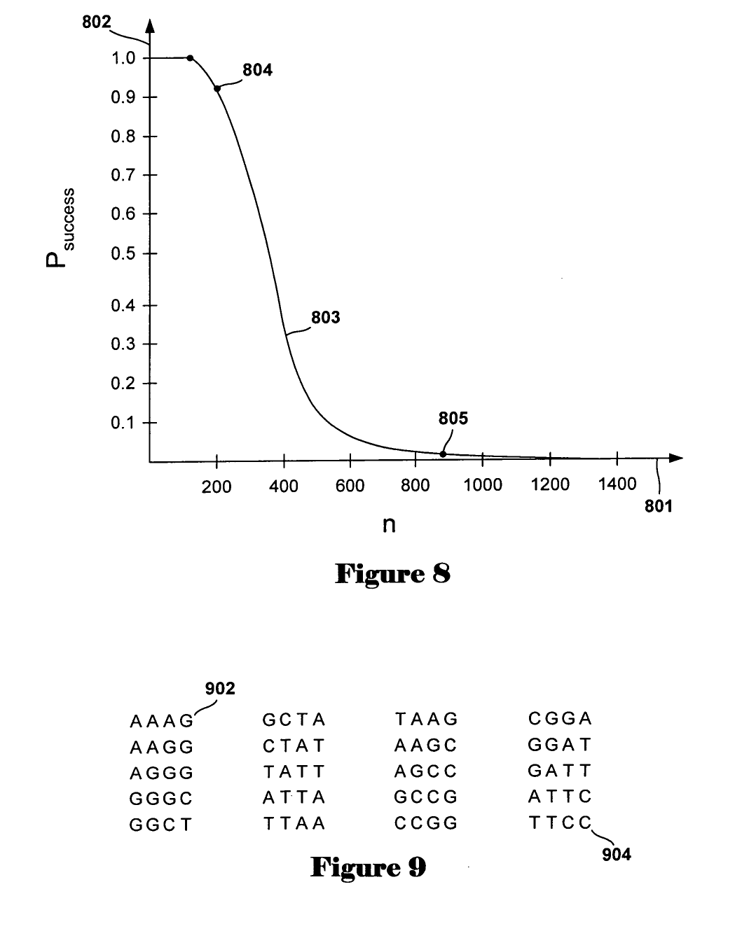

Each microarray may cover an area of less than 100 cm², or even less than 50 cm², 10 cm² or 1 cm². In many embodiments, the substrate carrying the one or more microarrays (see e.g., FIG. 8) will be shaped generally as a rectangular solid having a length of more than 4 mm and less than 1 m, usually more than 4 mm and less than 600 mm, more usually less than 400 mm; a width of more than 4 mm and less than 1 m, usually less than 500 mm and more usually less than 400 mm; and a thickness of more than 0.01 mm and less than 5.0 mm, usually more than 0.1 mm and less than 2 mm and more usually more than 0.2 and less than 1 mm. Other shapes are possible, as well. With microarrays that are read by detecting fluorescence, the substrate may be of a material that emits low fluorescence upon illumination with the excitation light. Additionally in this situation, the substrate may be relatively transparent to reduce the absorption of the incident illuminating laser light and subsequent heating if the focused laser beam travels too slowly over a region. For example, a substrate may transmit at least 20%, or 50% (or even at least 70%, 90%, or 95%), of the illuminating light incident on the front as may be measured across the entire integrated spectrum of such illuminating light or alternatively at 532 nm or 633 nm.

Microarrays can be fabricated using drop deposition from pulsejets of either polynucleotide precursor units (such as monomers) in the case of in situ fabrication, or the previously obtained polynucleotide. Such methods are described in detail in, for example, U.S. Pat. No. 6,242,266, U.S. Pat. No. 6,232,072, U.S. Pat. No. 6,180,351, U.S. Pat. No. 6,171,797, U.S. Pat. No. 6,323,043, U.S. patent application Ser. No. 09/302,898 filed Apr. 30, 1999 by Caren et al., and the references cited therein. Other drop deposition methods can be used for fabrication, as previously described herein. Also, instead of drop deposition methods, photolithographic microarray fabrication methods may be used. Interfeature areas need not be present particularly when the microarrays are made by photolithographic methods as described in those patents.

A microarray is typically exposed to a sample including labeled target molecules, or, as mentioned above, to a sample including unlabeled target molecules followed by exposure to labeled molecules that bind to unlabeled target molecules bound to the microarray, and the microarray is then read. Reading of the microarray may be accomplished by illuminating the microarray and reading the location and intensity of resulting fluorescence at multiple regions on each feature of the microarray. For example, a scanner may be used for this purpose, which is similar to the AGILENT MICROARRAY SCANNER manufactured by Agilent Technologies, Palo Alto, Calif. Other suitable apparatus and methods are described in published U.S. patent applications 20030160183A1, 20020160369A1, 20040023224A1, and 20040021055A, as well as U.S. Pat. No. 6,406,849. However, microarrays may be read by any other method or apparatus than the foregoing, with other reading methods including other optical techniques, such as detecting chemiluminescent or electroluminescent labels, or electrical techniques, for where each feature is provided with an electrode to detect hybridization at that feature in a manner disclosed in U.S. Pat. No. 6,251,685, and elsewhere.

A result obtained from reading a microarray, followed by application of a method of the present invention, may be used in that form or may be further processed to generate a result such as that obtained by forming conclusions based on the pattern read from the microarray, such as whether or not a particular target sequence may have been present in the sample, or whether or not a pattern indicates a particular condition of an organism from which the sample came. A result of the reading, whether further processed or not, may be forwarded, such as by communication, to a remote location if desired, and received there for further use, such as for further processing. When one item is indicated as being remote from another, this is referenced that the two items are at least in different buildings, and may be at least one mile, ten miles, or at least one hundred miles apart. Communicating information references transmitting the data representing that information as electrical signals over a suitable communication channel, for example, over a private or public network. Forwarding an item refers to any means of getting the item from one location to the next, whether by physically tran-sporting that item or, in the case of data, physically transporting a medium carrying the data or communicating the data.

As pointed out above, microarray-based assays can involve other types of biopolymers, synthetic polymers, and other types of chemical entities. A biopolymer is a polymer of one or more types of repeating units. Biopolymers are typically found in biological systems and particularly include polysaccharides, peptides, and polynucleotides, as well as their analogs such as those compounds composed of, or containing, amino acid analogs or non-amino-acid groups, or nucleotide analogs or non-nucleotide groups. This includes polynucleotides in which the conventional backbone has been replaced with a non-naturally occurring or synthetic backbone, and nucleic acids, or synthetic or naturally occurring nucleic-acid analogs, in which one or more of the conventional bases has been replaced with a natural or synthetic group capable of participating in Watson-Crick-type hydrogen bonding interactions. Polynucleotides include single or multiple-stranded configurations, where one or more of the strands may or may not be completely aligned with another. For example, a biopolymer includes DNA, RNA, oligonucleotides, and PNA and other polynucleotides as described in U.S. Pat. No. 5,948,902 and references cited therein, regardless of the source. An oligonucleotide is a nucleotide multimer of about 10 to 100 nucleotides in length, while a polynucleotide includes a nucleotide multimer having any number of nucleotides.

As an example of a non-nucleic-acid-based microarray, protein antibodies may be attached to features of the microarray that would bind to soluble labeled antigens in a sample solution. Many other types of chemical assays may be facilitated by microarray technologies. For example, polysaccharides, glycoproteins, synthetic copolymers, including block copolymers, biopolymer-like polymers with synthetic or derivitized monomers or monomer linkages, and many other types of chemical or biochemical entities may serve as probe and target molecules for microarray-based analysis. A fundamental principle upon which microarrays are based is that of specific recognition, by probe molecules affixed to the microarray, of target molecules, whether by sequence-mediated binding affinities, binding affinities based on conformational or topological properties of probe and target molecules, or binding affinities based on spatial distribution of electrical charge on the surfaces of target and probe molecules.

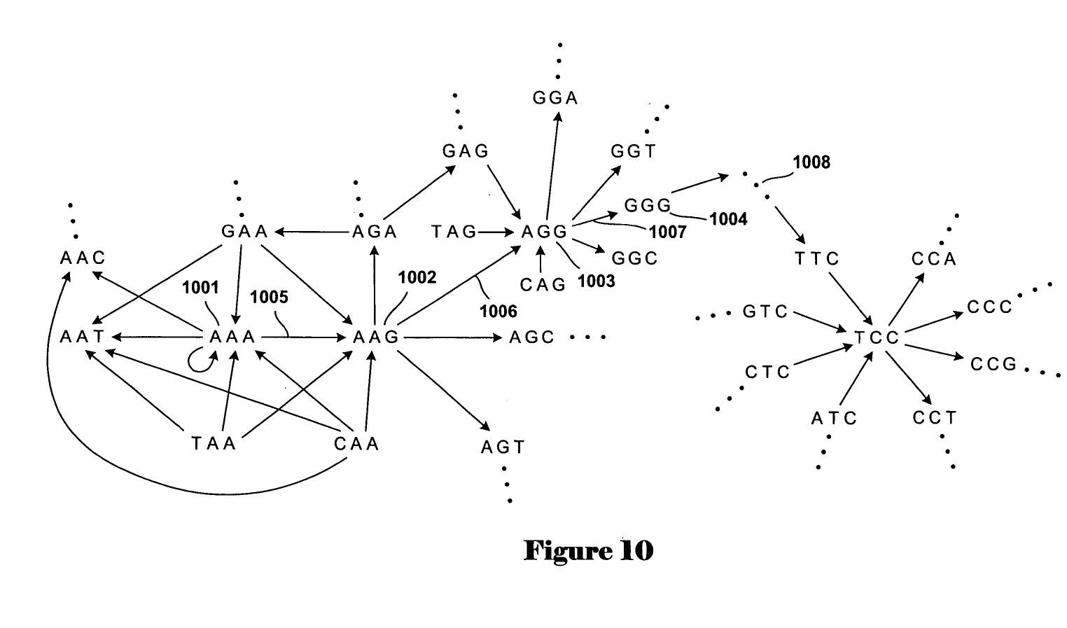

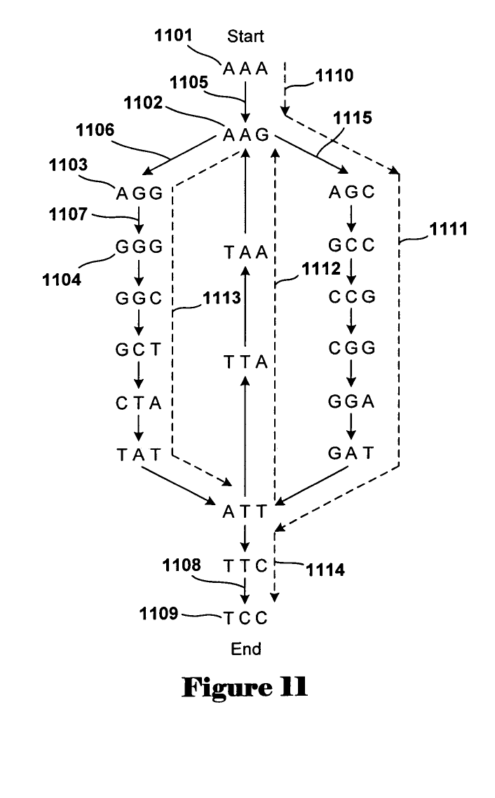

As described above with reference to FIGS. 9-10, reading of a microarray by an optical reading device or radiometric reading device generally produces an image comprising a rectilinear grid of pixels, with each pixel having a corresponding signal intensity. These signal intensities are processed by a microarray-data-processing program that analyzes data scanned from an microarray to produce experimental or diagnostic results which are stored in a computer-readable medium, transferred to an intercommunicating entity via electronic signals, printed in a human-readable format, or otherwise made available for further use. Microarray experiments can indicate precise gene-expression responses of organisms to drugs, other chemical and biological substances, environmental factors, and other effects. Microarray experiments can also be used to diagnose disease, for gene sequencing, and for analytical chemistry. Processing of microarray data can produce detailed chemical and biological analyses, disease diagnoses, and other information that can be stored in a computer-readable medium, transferred to an intercommunicating entity via electronic signals, printed in a human-readable format, or otherwise made available for further use.

### Additional Information about Sequencing by Hybridization

In the following discussion and in subsequent subsections, a target molecule, denoted by s, is used to present the principles of the present invnetion. The general principles of the SBH method are presented below with reference to mathematical concepts and by way of an example application, shown below in FIGS. 9-14, on a hypothetical target molecule that cannot be uniquely reconstructed using the SBH method alone.

The length of a target molecule s is denoted by length(s), and the starting and ending subsequences are denoted by start(s) and end(s), respectively. The quantities length(s), start(s) and end(s) can be provided as input. Note that the present invention does not require that information regarding start(s) and end(s) to be known before hand. The SBH method employs a microarray-based hybridization assay to determine all k-mer nucleic acid subsequences of the target molecule s. The k-mers of target molecule s can be determined by amplifying and chopping target molecule s into fragments and labeling each fragment with fluorophores, chemiluminescent compounds, or radioactive atoms. The microarray-based hybridization assay is conducted by exposing the labeled target molecule s fragments to a microarray composed of all possible k-mer oligonucleotide probes. The number of different k-mer oligonucleotide probe sequences used for the microarray-based hybridization assay is 4^{k}. Note that a typical microarray-based hybridization assay may employ oligonucleotide probes of length about 6 or more bases. Reading the microarray following hybridization reveals the k-mer sequences of target molecule s. The full set of k-mer subsequences of target molecule s is called the spectrum of target molecule s and is denoted by σₖ(s). Mathematically, the SBH spectrum of target molecule s is defined by a function σₖ(s): k−mers→{0,1} given by:

$${σ}_{k} ( s ) ( w ) = \{ \begin{matrix}1 & if w is a subsequence in s \\ 0 & otherwise\end{matrix}$$

In general, the longer a target molecule sequence the higher the probability that the target molecule will share an identical spectrum with other nucleic acid molecules of the same length but with different nucleic acid sequences. Mathematically stated, for a target molecule a and any other nucleic acid molecule b having a nucleic acid sequence different from that of a, if length (a)=length (b)>2^{k}, then there is a significant probability that σₖ(a)=σₖ(b). On the other hand, as the lengths of molecules a and b decrease, such as length (a)=length (b)=k, then the probability of σₖ(a)≠σₖ(b) increases.

FIG. 9 shows a hypothetical spectrum σ₄(s) associated with a hypothetical target molecule of length 23. In FIG. 9, the spectrum σ₄(s) is comprised of 20 4-mers read from a hypothetical microarray-based hybridization assay using all possible 4-mer probes. Sequence 902 identifies start(s) of the hypothetical target molecule as the sequence “AAAG,” and sequence 904 identifies end(s) of the hypothetical target molecule as the sequence “TTCC.” Note that the spectrum does not reveal the location of any 4-mer subsequence in the hypothetical target molecule, nor does the spectrum indicate the number of times a 4-mer sequence is repeated in the hypothetical target molecule.

Once the spectrum of a target molecule s has been determined from a microarray-based hybridization assay, a set S of candidate molecules denoted by tᵢ, where i is the candidate molecule index, can be generated by one of many possible combinatorial methods used to reconstruct the nucleic acid sequence of the target molecule s from the spectrum σₖ(s). The combinatorial method presented in this subsection employs concepts from graph theory, such as a directed de Bruijn graph. The directed de Bruijn graph is composed of nodes that correspond to all nucleic acid (k−1)-mers and edges that identify the k-mer sequences that overlap the prefix base and suffix base of each pair of nodes. The directed de Bruijn graph is mathematically defined by:
Bₖ₋₁=(V,E)

where V is the set of all (k−1)-mers as nodes; and
E is the set of all k-mers as edges connecting certain nodes of V
   The subscript (k−1) is referred to as the “rank” of the de Bruijn graph Bₖ₋₁ and is based on the length of the k-mer sequences in the spectrum σₖ(s). For example, the rank of the de Bruijn graph associated with hypothetical spectrum σ₄(s), described above with reference to FIG. 9, is 3 and is denoted by B₃.

FIG. 10 illustrates part of the rank 3 de Bruijn graph B₃. A full de Bruijn graph B₃ has 4³ or 64 3-mer nodes and 4⁴ or 256 4-mer edges. However, due to the large number of 3-mer nodes and 4-mer edges in B₃, only a portion of the nodes and the edges of B₃ are illustrated in FIG. 10. The set of nodes V of B₃, such as nodes 1001-1004, represent 3-mers, and the set of edges E of B₃, such as edges 1005-1007, represent 4-mers. The three dots, such as three dots 1008, represent the 3-mer nodes and 4-mer edges not shown.

The edges in a directed de Bruijn graph Bₖ₋₁ are identified by arrows directed from a first node, denoted by u, to a second node, denoted by v. For example, in FIG. 10, edge 1005 points from node 1001 to node 1002. Each edge u→v of Bₖ₋₁ represents a k-mer, cXd, where u and v are the (k−1)-mer nodes cX and Xd in V, respectively, c and d are nucleotide bases, and X is the (k−2)-suffix of node u that matches the (k−2)-prefix of node v. For example, in FIG. 10, edge 1005 represents the 4-mer “AAAG.” Nodes 1001 and 1002 can be combined to give edge 1005 because the 2-mer suffix of node 1001, sequence “AA,” matches or overlaps the 2-mer prefix of node 1002.

Each path of nodes in a directed deBruijn graph Bₖ₋₁ corresponds to a different nucleic acid molecule. For example, the path of nodes 1001-1004, following the direction of edges 1005-1007, represents nucleic acid molecule “AAAGGG.” Starting node 1001 provides the first three nucleotides “AAA” of the nucleic acid molecule “AAAGGG.” Subsequent nucleotides are constructed by appending the last nucleotide of each node to the sequence along the direction of edges 1005-1007. For example, the last nucleotide of node 1002 “G” is appended to the end of starting sequence “AAA” to give the sequence “AAAG,” and the last nucleotides of nodes 1003 and 1004 are both “G” and appended in order to the end of sequence “AAAG” to give the nucleic acid molecule “AAAGGG.”

The path of edges and nodes in Bₖ₋₁ can be used to construct candidate molecules tᵢ having the spectrum σₖ(s) by retaining only those edges in Bₖ₋₁ that are also k-mer sequences in the spectrum σₖ(s). The resulting directed graph is a de Bruijn subgraph of Bₖ₋₁ denoted by:
G(σₖ(s))=(V*,E*)

where V* is a subset of V, and
E*={(u→v): u=aX; v=Xb; a,bε{A, C,G,T};σₖ(s)(aXb)=1}

is a subset of E.

All edges of the directed graph G(σₖ(s)) represent the k-mers in the spectrum σₖ(s).

FIG. 11 illustrates the full directed sub-graph G(σ₄(s)) of the de Bruijn graph B₃, shown in FIG. 10. For example, in FIG. 11, nodes 1101-1104 correspond to nodes 1001-1004 in FIG. 10, respectively, and edges 1105-1108 correspond to edges 1005-1008 in FIG. 10, respectively. The edges of G(σ₄(s)) represent the 4-mers in the spectrum σ₄(s). For example, edges 1105-1108 represent the nucleic acid sequences “AAGG,” “AGGG,” “AAGG,” and “TTCC,” respectively, in the spectrum σ₄(s), shown in FIG. 10. Note that edges 1105 and 1109 correspond to start(s) and end(s), respectively, for the hypothetical target molecule.

The SBH method generates candidate molecules tᵢ by traversing paths of edges, denoted by πᵢ, in the directed graph G(σₖ(s)) that start with the edge corresponding to start(s), end with the edge corresponding to end(s), traverse all edges in G(σₖ(s)), and have a path length equal to the depth bound. The depth bound is the maximum number of edges that a path πᵢ can traverse in G(σₖ(s)) to ensures that the length of the corresponding candidate molecule tᵢ does not exceed length(s). The depth bound can be determined by the expression:
(length(s)−k+1)
For the hypothetical target molecule, length(s) is 23 and each edge in σ₄(s) is a 4-mer sequence. Therefore, the depth bound of the paths that traverse all edges in G(σ₄(s)) is “20.” Note that paths πᵢ that traverse all edges in G(σₖ(s)) correspond to candidate molecules tᵢ that have a spectrum σ(tᵢ) that is identical to the target molecule s spectrum σₖ(s) because the set of edges E* is identical to the spectrum σₖ(s). Paths that start with start(s), end with end(s), traverse all edges in G(σₖ(s)), and have a path length equal to the depth bound are said to be SBH consistent with target molecule s.

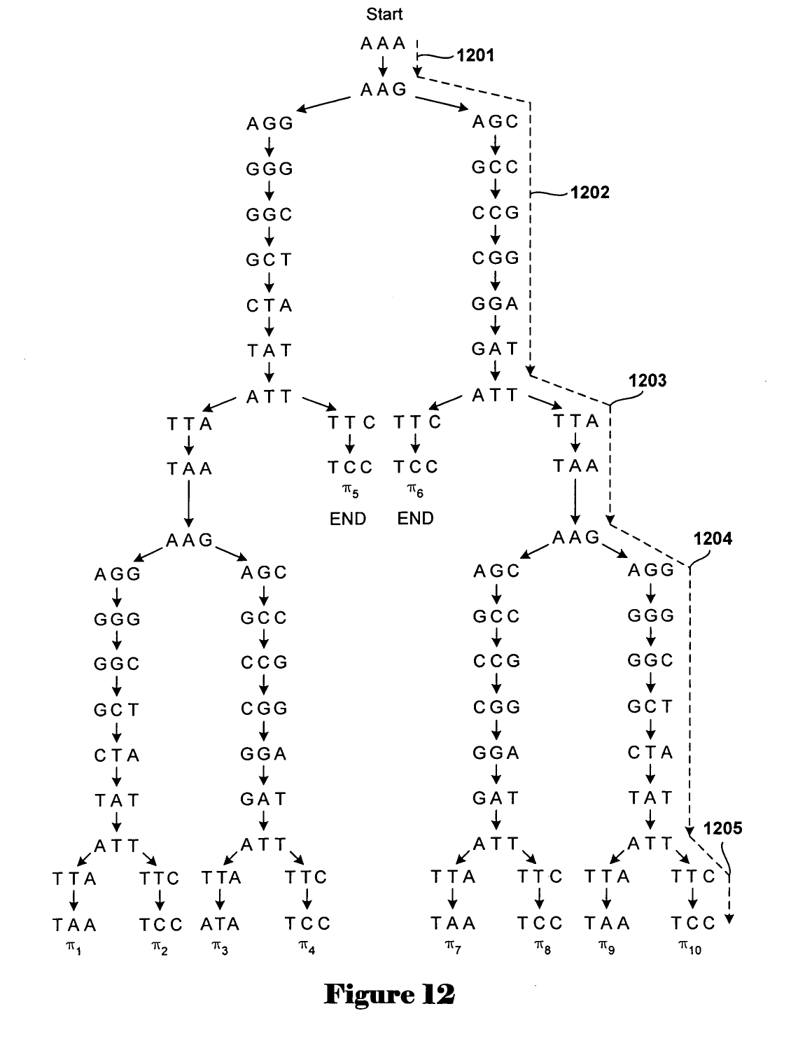

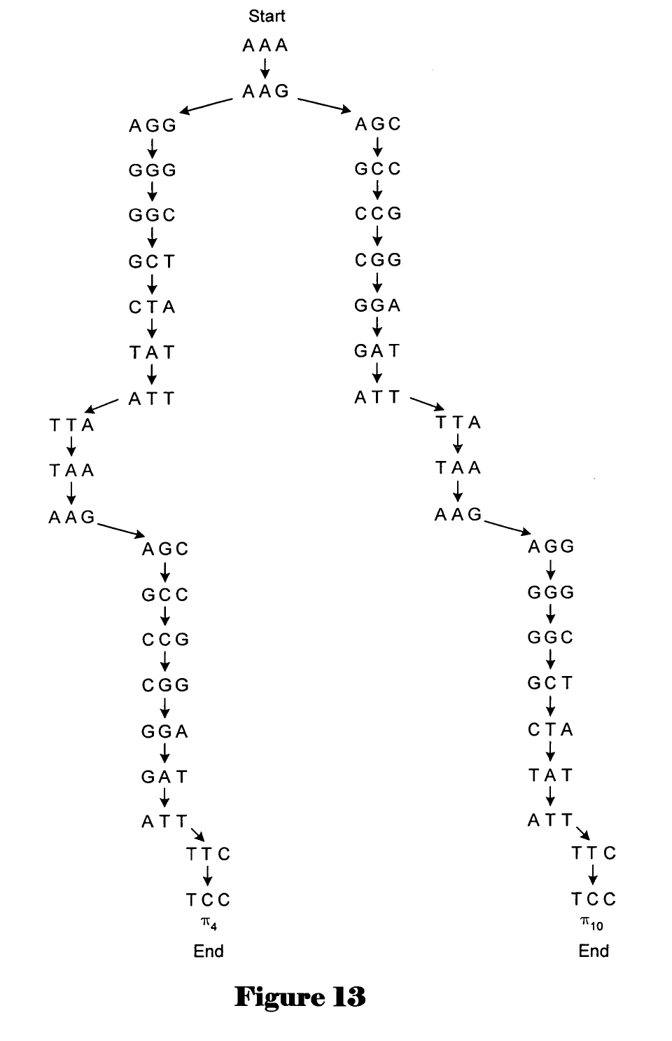

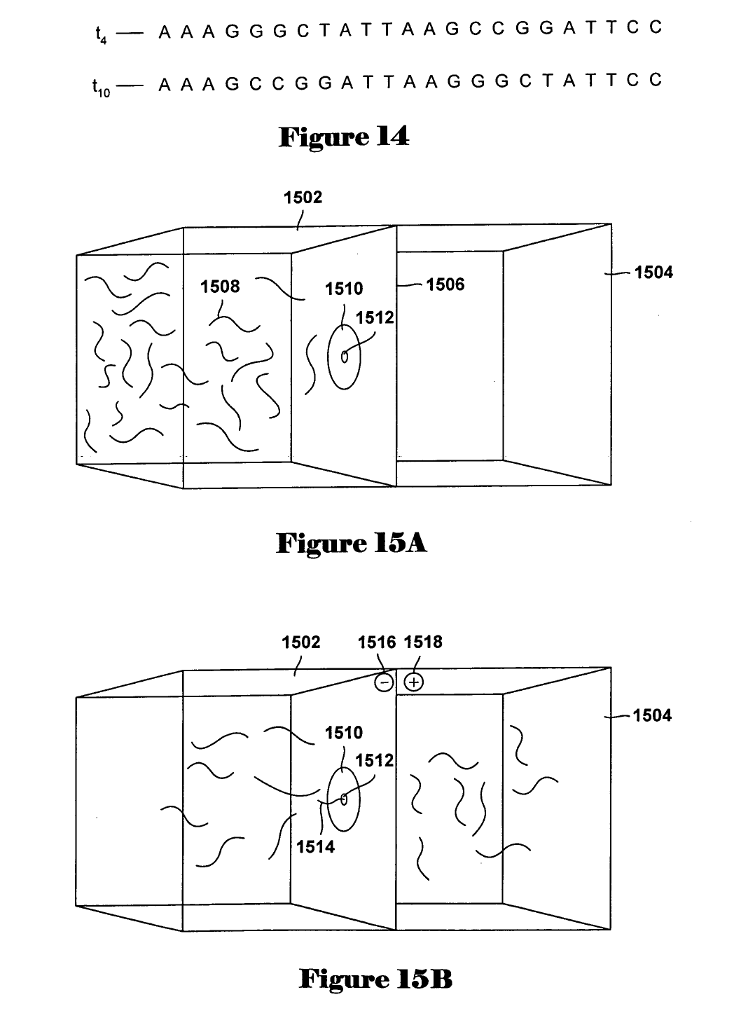

A directed tree, denoted by T, can be used to displaying all paths πᵢ in G(σₖ(s)) whose root node corresponds to start(s), and all paths in directed tree T beginning at the root are all of length at most equal to the depth bound. FIG. 12 illustrates a directed tree T that displays all the paths in G(σ₄(s)) with a depth bound less than or equal to 20. Note that every node in directed tree T is labeled by the corresponding node in V* of G(σ₄(s)). In FIG. 12, the directed tree T begins with root node 1201 which corresponds to node 1101, shown in FIG. 11. Each path of edges, shown in FIG. 12, is labeled at the bottom π₁-π₁₀. The paths π₁-π₁₀ in T are constructed by traversing the paths of edges of G(σ₄(s)), shown in FIG. 11. For example, the path π₁₀, shown in FIG. 12, identified by directed dashed lines 1201-1205, is constructed by following, in order, the path of edges identified by directed dashed lines 1110-1114, respectively, shown in FIG. 11. In FIG. 12, the paths that are SBH consistent with the hypothetical target molecule are paths π₄ and π₁₀ because paths π₄ and π₁₀ start with start(s), end with end(s), traverse all edges of G(σ₄(s)), and equal the depth bound of “20.” FIG. 13 shows paths π₄ and π₁₀ after the branches leading to the paths π₁-π₃, π₅-π₉ are pruned. FIG. 14 shows the candidate molecules t₄ and t₁₀ sequences that correspond to surviving paths π₄ and π₁₀. The SBH method is unable to further determine which candidate molecule, t₄ or t₁₀, corresponds to the hypothetical target molecule s.

The number of candidate molecules tᵢ generated from a directed graph G(σₖ(s)) that are SBH consistent with a target molecule s increases exponentially with the length of the target molecule s. Therefore, more target molecule sequence information is needed to aid in eliminating candidate molecules tᵢ that have been determined using the SBH method.

### Obtaining Decoration Patterns using Nanopore Technology

Nanopore technology can be used for the detection, identification and quantification of many different nucleic acid molecules in a mixture, such as differences in molecule length, composition, and structure. (Meller, A., L. Nivon, and D. Branton, “Voltage-driven DNA Translocations Through a Nanopore,” Phys. Rev. Lett., 86: 3435-3438, 2000; and D. W. Deamer and D. Branton, D., “Characterization of Nucleic Acids by Nanopore Analysis,” Acc. Chem. Res., 35: 817-825, 2000). A nanopore detector permits identification and characterization of a specific type of DNA and RNA molecule as the molecule moves through a nanopore in the nanopore detector. Detection and characterization can be obtained with high precision from extremely small samples and/or relatively dilute or low-abundance nucleic acid samples.

A nanopore detector includes a surface having a groove or aperture. FIGS. 15A-B illustrate a hypothetical nanopore aperture located in a barrier separating two volumes. FIG. 15A shows two volumes 1502 and 1504 separated by a barrier 1506. Volume 1502 contains a solution of nucleic acid molecules 1508. The nanopore 1510 is located in the center of barrier 1506 and is composed of an elastic disk-shaped region with a central, nanometer scale sized aperture 1512 through which the nucleic acid molecules in volume 1502 may pass through into the second volume 1504. The nanometer scale size aperture 1512 is dimensioned to accommodate a single polymer at any given instant in time. The nanopore aperture 1512 may range from about 1.5 nm to about 2.5 nm in diameter in order to allow for passage of a double stranded nucleic acid molecule. Larger nanopore apertures may range from about 3 nm to about 4 nm and may be needed to accommodate passage of double stranded nucleic acid molecules with bound zinc finger proteins. For double stranded nucleic acid molecules bound to molecules larger than zinc finger proteins, the nanopore aperture may range from about 4 nm to about 5 nm in diameter.

FIG. 15B illustrates a nucleic acid molecule traversing aperture 1512 in nanopore 1510. In FIG. 15B, an appropriate voltage bias is applied across the nanopore 1510 to provide a driving force for pulling nucleic acids 1508 through aperture 1512 in one dimension. When no voltage bias is applied across nanopore 1510, the nucleic acid molecules remain in volume 1502 or may drift randomly through opening 1512 into volume 1504. When a voltage bias is applied across nanopore 1512, the monomer units of each nucleic acid molecule pass through the nanopore aperture 1512 in sequential order and can initiate with either the 3′ or 5′ end. The voltage bias is created by placing a negative charge 1516 on the side of the barrier 1506 in volume 1502 and a positive charge 1518 on the side of the barrier 1506 in volume 1504. Since each nucleic acid molecule 1508 is negatively charged, the nucleic acid molecules are pulled one nucleic acid unit at a time through aperture 1512 into the positively biased side of the barrier 1506. In FIG. 15B, aperture 1512 is dimensioned so that only a single nucleic acid molecule, such as molecule 1514, can pass through aperture 1512 at a time. As molecule 1514 passes through aperture 1512, the current across aperture 1512 is reduced, because molecule 1514 acts as a resistor to the flow of current across aperture 1512. As each nucleic acid molecule passes through aperture 1512, portions of the molecule having greater cross-sectional areas generally reduce the flow of current across the aperture 1512 more than portions of the molecule having smaller cross-sectional areas. An amplifier or recording device may be used to detect current fluctuations across the aperture as a nucleic acid molecule traverses the aperture. Although the current may fluctuate with the cross-sectional area of the nucleic acid molecule, current may also fluctuate with respect to the charge density differences along the length of the nucleic acid molecule. The chemical nature of components within, or bound to, the nucleic acid molecule, and with respect to other chemical and structural features that vary along the length of the molecule may also contribute to fluctuations in the flow of current across a nanopore aperture. The current fluctuation may be recorded in a graph of the current versus time to produce a visual image of chemical features along the molecule.

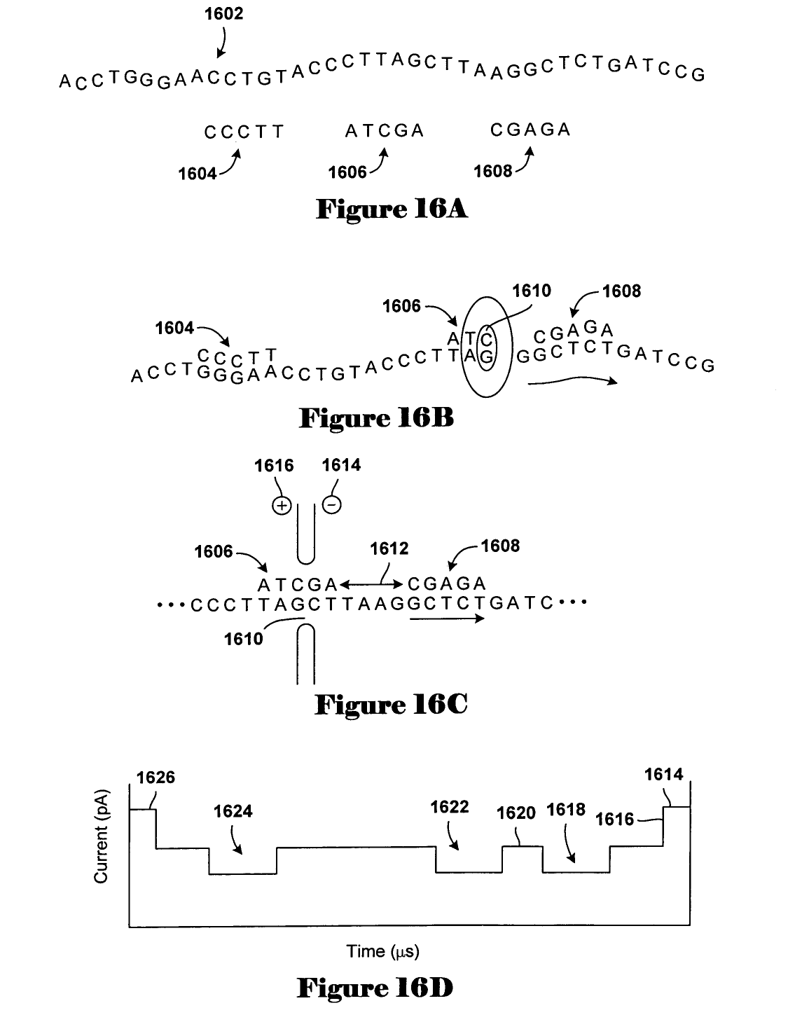

FIGS. 16A-D provide an example illustrating how changes in the flow of current across the nanopore aperture may be utilized to determine the presence of subsequences in single-stranded DNA (“ssDNA”). FIG. 16A shows the sequences of an ssDNA 1602 and three oligonucleotides 1604, 1606 and 1608, each having complementary subsequences of ssDNA 1602. FIG. 16B illustrates oligonucleotides 1604, 1606, and 1608 hybridized to complementary subsequences of ssDNA 1602 as the oligonucleotide/ssDNA complex passes through nanopore aperture 1610. The pattern of bound oligonucleotides is called a decoration pattern. FIG. 16C is a cross-sectional illustration of the oligonucleotide/ssDNA complex passing through aperture 1610. Positive and negative charges 1614 and 1616, respectively, are identified on opposite sides of aperture 1610. The oligonucleotide/ssDNA complex includes a gap 1612 distance between oligonucleotides 1606 and 1608. As the oligonucleotide/ssDNA complex passes through aperture 1610, the current across the aperture is reduced by an amount proportional to the cross-sectional area of the oligonucleotide/ssDNA complex. The current reduction is greater for those portions at the oligonucleotide/ssDNA complex, such as bound oligonucleotides 1606 and 1608, than for purely single stranded portions of the ssDNA, such as gap 1612.

FIG. 16D illustrates the changes in current observed as the oligonucleotide/ssDNA complex, shown in FIG. 16C, traverses the nanopore aperture. The decoration pattern (“DP”) is reflected by the change in current with time as the oligonucleotide/ssDNA complexes pass through aperture 1610. The current across the nanopore aperture prior to ssDNA 1602 entering the aperture is indicated by the value of the current at position 1614. As ssDNA 1602 enters the aperture, ssDNA 1602 acts as a resistor by reducing the flow of current across the aperture. The increased resistance due to the entry of ssDNA 1602 is indicated by current decrease 1616. As ssDNA 1602 continues to pass through the nanopore aperture, the current remains relatively constant until the first oligonucleotide 1608 hybridized to ssDNA 1602 is reached. Due to the increase in cross-sectional area of the oligonucleotide/ssDNA complex, the resistance increases, causing a further decrease in the current. The further current decrease associated with the oligonucleotide/ssDNA complex is called an event. Event 1618 identifies the probe 1608/ssDNA complex passing through the nanopore aperture. Once the oligonucleotide/ssDNA complex has passed through the aperture, the resistance decreases and the current is restored to that of the ssDNA 1602 at current level 1620. As the second oligonucleotide 1606 passes through aperture 1610 the current decreases to give event 1622. Event 1624 represents oligonucleotide 1604 hybridized to ssDNA 1602. The region between events 1622 and 1624 represents the restored current level of uncomplexed ssDNA.

The example illustrated in FIGS. 16A-D illustrates employing oligonucleotide probes to determine the presence and relative location of subsequences in ssDNA. The approximate location of particular subsequences in ssDNA can be determined by using oligonucleotide probes having different lengths. For oligonucleotides of different lengths, the current-based image of the decoration pattern may show a correlation between the length of bound oligonucleotide probes and the duration of an associated event. Moreover, molecules and atoms having known and different resistances may be used to reveal the approximate location and identity of subsequences in ssDNA. For example, oligonucleotide probes having identical nucleotide sequences can each be bound with a particular molecule or atom that gives a known current resistance in a current-based image decoration pattern. The known current resistance can be used to determine the presence and approximate location of particular subsequences of the ssDNA.

The nanopore aperture can be increased to permit passage of molecules having a cross-sectional area larger than an oligonucleotide/ssDNA complex. For example, zinc finger proteins (“ZFP”) can be chosen to bind to specific sites on double-stranded DNA (“dsDNA”) in order to produce current-based images of ZFP-decoration patterns, analogous to those produced by the oligonucleotide/ssDNA complexes in FIG. 9D, for determining the presence of complementary subsequences within a dsDNA. ZFPs typically contain several fingers, each comprised of about 30 amino acids. About 9 of the amino acids in each finger bind to specific adjacent nucleic acid base pairs within a nucleic acid molecule.

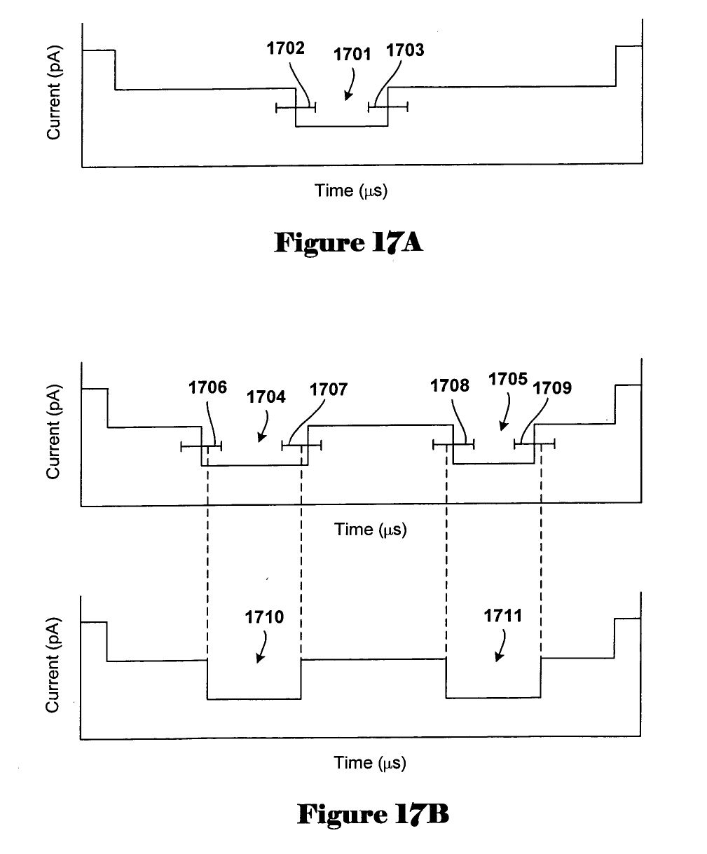

The events illustrated in FIG. 16D represent idealized high-resolution results from hypothetical nanopore hybridization assays. The duration and location of events taken from typical nanopore hybridization assays are approximations. FIG. 17A illustrates the difference between results obtained from high-resolution nanopore assays and low-resolution nanopore assays. In FIG. 17A, event 1701 identifies a high-resolution, probe/nucleic-acid-molecule complex, and low-resolution error bounds 1702 and 1703. The duration of the low-resolution event observed for a probe/nucleic-acid-molecule complex can range in duration and location between the error bounds 1702 and 1703. A low-resolution nanopore hybridization assays employing two more oligonucleotide probes of different lengths may give rise to events that are difficult, if not impossible, to distinguish. FIG. 17B illustrates a high resolution and a low resolution current-based image decoration patterns produced by hybridizing a nucleic acid molecule in solution with two probes having different lengths. In FIG. 17B, the top current-based image decoration pattern exhibits high resolution events 1704 and 1705. Note that with high resolution nanopore assays, the event durations are proportional to the oligonucleotide probe length and can be used to identify subsequences of the target molecule. However, for low-resolution nanopore assays, distinguishing events can be difficult as indicated by error bounds 1706 and 1707 associated with event 1704 and error bounds 1708 and 1709 associated with event 1705. In the bottom current-based image decoration pattern, low resolution events 1710 and 1711 appear indistinguishable making it difficult to associate an event with a particular oligonucleotide-probe length.

Note that the length of event error bounds is based on the resolution of the nanopore hybridization assay. For high-resolution nanopore assays, the length of the error bounds may be short making identification of oligonucleotide-probe/nucleic-acid-molecule complexes possible based on the associated oligonucleotide probe length. However, for low-resolution nanopore hybridization assays, large event error bounds make identifying oligonucleotide-probe/nucleic-acid-molecule complexes difficult, if not impossible. Therefore, separate nanopore assays can be run for different oligonucleotide probes in order to ensure the presence of a particular complementary subsequence of the nucleic acid molecule.

### Embodiments of the Present Invention

Various embodiments of present invention are directed to methods that relate to sequencing a target molecule s by combining the SBH spectrum σₖ(s) information with DP information. In one embodiment of the present invention, a directed tree, denoted by T, is generated and branches are pruned by discarding branches that correspond to candidate molecule sequences that are either not SBH consistent or not DP consistent with the nucleic acid sequence of target molecule s. The hypothetical target molecule, described above with reference to FIGS. 9-14, is used to illustrate an application of one of many possible embodiments of the present invention that reconstructs the unique hypothetical target molecule sequence using spectrum σ₄(s) information and DP information obtained from a hypothetical nanopore assay.

Initially, the SBH method is used to determine the spectrum σₖ(s) and the de Bruijn directed subgraph G(σₖ(s)), as described above with reference to FIGS. 9-11. The subsequences of a target molecule s are constructed by collapsing consecutive nodes of the directed graph G(σₖ(s)) having out degree equal to “1.” The out degree of a node is the number of edges directed from the node. For example, in FIG. 11, node 1103 has an out degree of “1” because only one edge, edge 1107, is directed from node 1103, while node 1102 is an out degree “2” node because 2 edges, edges 1106 and 1115, are directed from node 1102. The collapsed subsequences of target molecule s are denoted by fᵢ and are called SBH-fragments. For example, Table 1 displays the SBH-fragments of the directed graph G(σ₄(s)) shown in FIG. 11:

TABLE 1

| | | |
|---|---|---|
| SBH-fragment | Sequence | Sequence length |

| | | |
|---|---|---|
| f₁ | “AAAG” | 4 |
| f₂ | “AAGCCGGATT” | 10 |
| f₃ | “AAGGGCTATT” | 10 |
| f₄ | “ATTCC” | 5 |
| f₅ | “ATTAAG” | 6 |

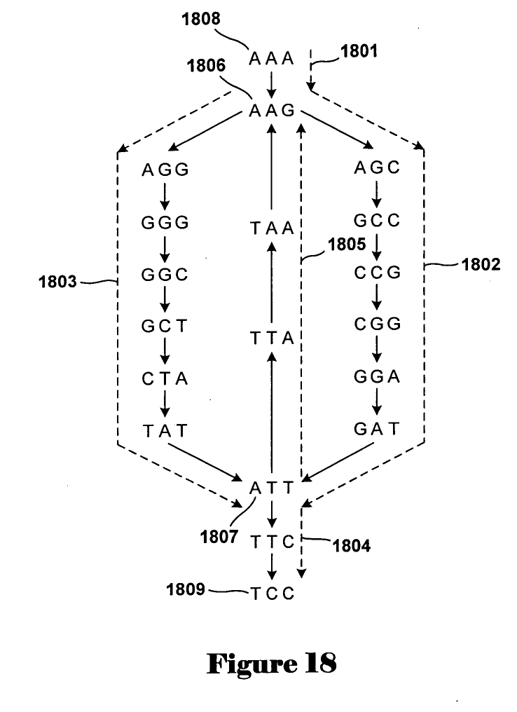

FIG. 18 shows the SBH-fragments f₁, f₂, f₃, f₄, and f₅ of the hypothetical target molecule that correspond to sub-paths in G(σ₄(s)). In FIG. 18, the SBH-fragments f₁, f₂, f₃, f₄, and f₅ are identified by directed dashed lines 1801-1805, respectively. The SBH-fragment sequences are determined, as described above with reference to FIG. 10. The length of the SBH-fragments are listed in the third column of Table 1.

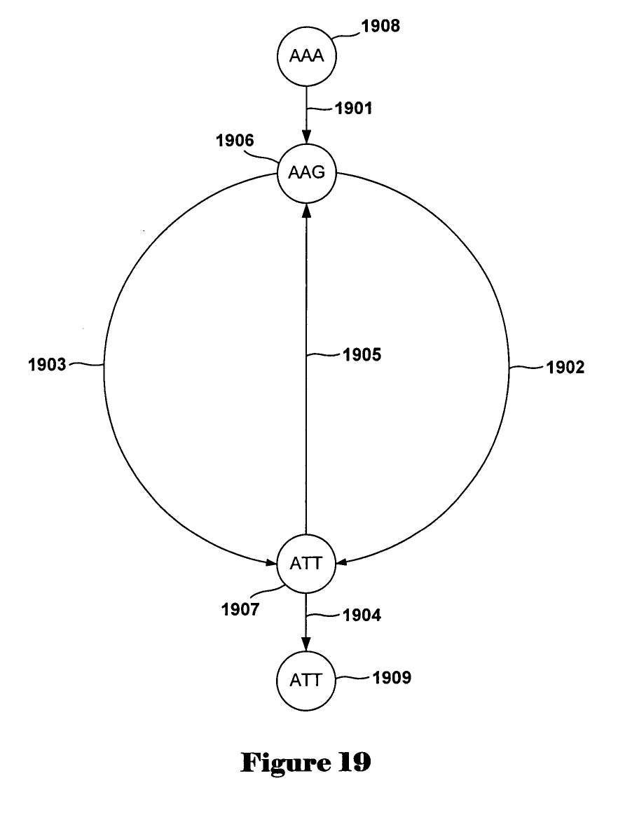

FIG. 19 illustrates a directed graph of the SBH-fragments displayed in Table 1. In FIG. 19, edges 1901-1905 represent fragments f₁, f₂, f₃, f₄, and f₅, respectively, nodes 1906 and 1907 represent the out degree “2” nodes 1806 and 1807, respectively, and nodes 1908 and 1909 represent the starting node 1808 and ending node 1809, respectively. Traversal of all k-mer edges in FIG. 18 is equivalent to traversal of all edges of the directed graph in FIG. 19.

Next, the DP of target molecule s is determined. The target molecule s decoration pattern is employed to reduce the number of possible candidate molecules that can be generated from the SBH spectrum σₖ(s). In one of many possible embodiments, one or more nanopore hybridization assays can be employed to determine one or more different decoration patterns of target molecule s by placing target molecule s in solution with about one or more different probes. In one embodiment, the probes chosen for hybridization with target molecule s may be oligonucleotides of varying length. For high-resolution current-based imaging of the decoration patterns, oligonucleotide probes of different length generate corresponding events of different lengths in the current-based image decoration patterns. The probes are prepared in advance with no knowledge regarding which probes will bind to subsequences of target molecule s. In one embodiment, nanopore hybridization assays may be run separately for each oligonucleotide probe in order to identify and determine the location of subsequences of target molecule s.

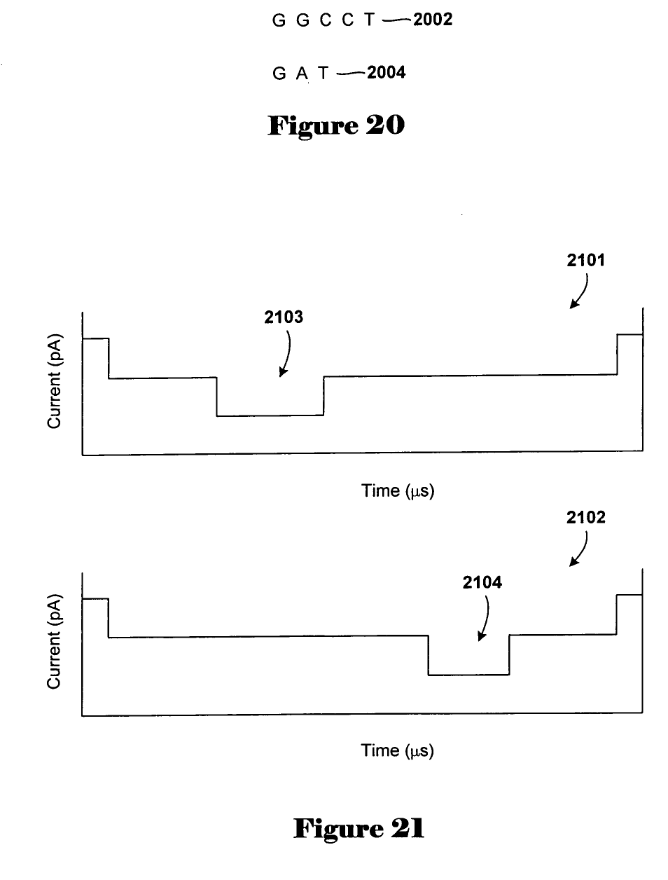

In the present example, separate nanopore hybridization assays can be conducted with different oligonucleotide probes of the same length. FIG. 20 shows two oligonucleotide probes 2002 and 2004 of different lengths employed to identify the decoration patterns of the hypothetical target molecule. FIG. 21 illustrates two hypothetical high-resolution, current-based image decoration patterns. In FIG. 21, current-based image 2101 identifies the decoration pattern for hypothetical target molecule in solution with probe 2002, and current-based image 2102 identifies the decoration pattern of the hypothetical target molecule in solution with probe 2004. Event 2103 confirms that the complementary subsequence, “CCGGA,” of probe 2002 is a subsequence of hypothetical target molecule s, and event 2104 confirms that the complementary subsequence, “CTA,” of probe 2004 is also a subsequence of the hypothetical target molecule. Note that, in the example, separate nanopore assays are conducted in order to determine the presence and approximate location of subsequences in the hypothetical target molecule. For example, in FIG. 21, the high-resolution images reveal the order in which subsequences “CTA” and “CCGGA” appear in the hypothetical target molecule. Subsequence “CTA” is close to the sequence start(s), as indicated by event 2104, which is followed by subsequence “CCGGA,” as indicated by event 2103.

After the directed graph G(σₖ(s)) of SBH-fragments and DP for the target molecule s have been determined, the root of the directed tree T is identified by the starting prefix sequence of target molecule s, start(s). For example, edge 1901 (fragment f₁), represents the nucleic acid sequence start(s) and is the root of the directed tree associated with the hypothetical target molecule.

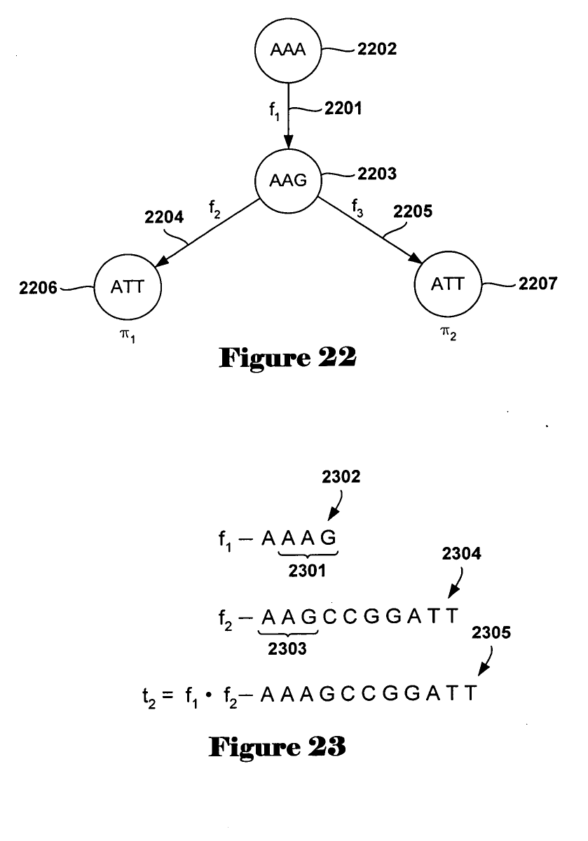

The branches of the directed tree T are added by expanding a first branching node of the directed graph G(σₖ(s)). FIG. 22 illustrates the root portion of the directed tree and expansion of the first node for the hypothetical target molecule. In FIG. 22, the root of the directed tree is edge 2201 which coincides with edge 1901, shown in FIG. 19. Nodes 2202 and 2203 coincide with nodes 1908 and 1906, respectively. In FIG. 22, the directed tree is expanded by adding edges 2204 and 2205 to node 2203. Edges 2204 and 2205 coincide with edges 1903 and 1904, respectively.

Next, the candidate molecules tᵢ are constructed from corresponding paths πᵢ in the directed tree T. The edges of the directed tree T define the paths πᵢ that correspond to prefix sequences of the candidate molecules tᵢ. For example, in FIG. 22, edges 2201 and 2204 define path π₁, and edges 2201 and 2205 define path π₂. Paths π₁ and π₂ represent the different prefix sequences of candidate molecules t₁ and t₂.

The prefix sequences of the candidate molecules tᵢ are determined by concatenating the SBH-fragments identified by the edges of the directed tree T. FIG. 23 illustrates concatenating the SBH-fragment f₁ (edge 2201 shown FIG. 22) and SBH-fragment f₂ (edge 2205 shown in FIG. 22), denoted by f₁·f₂, to give candidate molecule t₂. Overlapping (k−1)-mers, such as ending nucleotide 2301 of fragment f₁ 2302 and starting nucleotide 2303 of fragment f₂ 2304, appear one time in the concatenated nucleic acid molecule f₁·f₂ 2305.

The prefix sequences of candidate molecules tᵢ define a set S. For example, candidate molecules t₁ and t₂ associated with FIG. 22 define a set given by:

S = {t₁, t₂}
where t₁ = f₁ · f₂ = “AAAGCCGGATT,”
and
t₂ = f₁ · f₃ = “AAAGGGCTATT”

After each node is expanded, each path πᵢ is checked to determine which candidate molecules tᵢ are DP consistent and SBH consistent the target molecule. Those paths that are not DP consistent nor SBH consistent are pruned from the directed tree and the associated candidate molecule is removed from S.

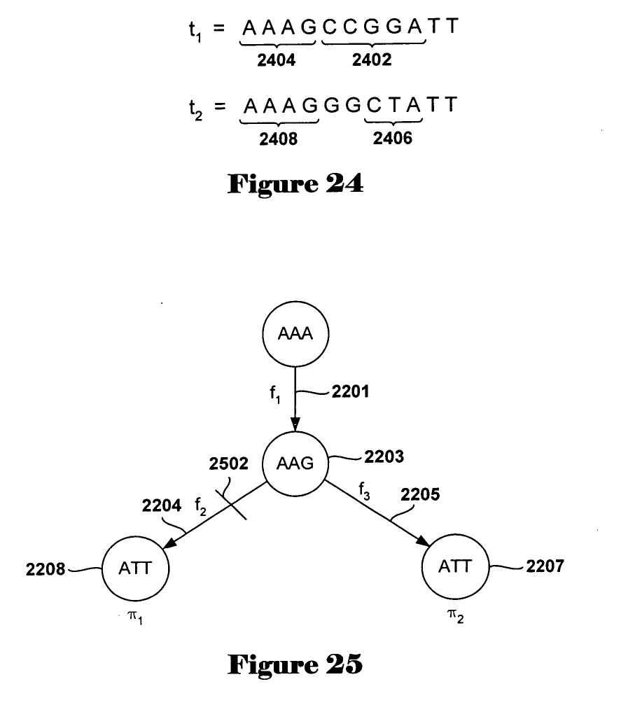

The current-based image decoration patterns resulting from the nanopore assay are compared with the sequences of candidate molecules tᵢ to determine which candidate molecules tᵢ are DP consistent with target molecule s. The candidate molecules tᵢ that are not DP consistent with target molecule s are discarded by pruning corresponding branches from the directed tree T. FIG. 24 shows candidate molecules t₁ and t₂ nucleic acid sequences. In FIG. 24, for candidate molecule t₁, the subsequence “CCGGA” 2402 is located near start(s) 2404, and for candidate molecule t₂, the subsequence “CTA” 2406 is located near start(s) 2408. However, the results of the hypothetical nanopore assays, shown in FIG. 21, confirm that subsequence “CTA” is closer to start(s) than the subsequence “CCGGA.” Candidate molecule t₁ is removed from the set S because candidate molecule t₁ is not DP consistent with the current-based decoration patterns shown in FIG. 21. FIG. 25 illustrates pruning the directed tree shown in FIG. 22. Edge 2204 is pruned from the directed tree shown in FIG. 22 because edge 2204 corresponds to candidate molecule t₁, as indicated by slash mark 2502.

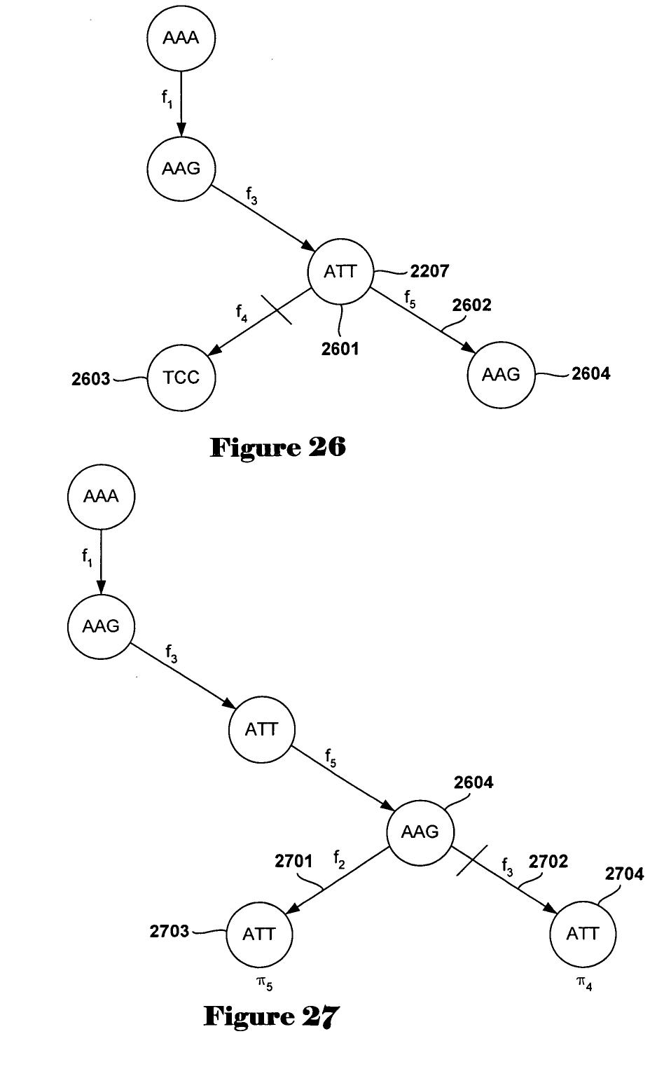

FIG. 26 illustrates expanding node 2207 by adding edges 2601 and 2602, which coincide with edges 1904 and 1905, respectively, of the graph shown in FIG. 19. Nodes 2603 and 2604 correspond to nodes 1909 and 1906, respectively. Candidate molecule t₂ is concatenated with the SBH fragments f₄ and f₅ to give:

S = {t₂, t₃}
where t₂ = t₂ · f₅ = “AAAGGGCTATTAAG,”
and
t₃ = t₂ · f₄ = “AAAGGGCTATTCC”

Note that both candidate molecules t₂ and t₃ are DP consistent with hypothetical target molecule. However, edge 2601 has reached ending node 2603. The four-base-tail sequence of candidate molecule t₃ is identical to end(s) (“TTCC”) and signifies that candidate molecule t₃ cannot be expanded further. Because the length of candidate molecule t₃ (13 bases) is less than length(s) (23 bases), edge 2601 is pruned from the directed tree T.

FIG. 27 illustrates expanding node 2604, shown in FIG. 26, by adding edges 2701 and 2702 which coincide with edges 1903 and 1902, respectively, of the graph shown in FIG. 19. Candidate molecule t₂ is concatenated with SBH fragments f₂ and f₃ to give:

S = {t₂, t₄}
where t₂ = t₂ · f₂ = “AAAGGGCTATTAAGCCGGATT,”
and
t₄ = t₂ · f₃ = “AAAGGGCTATTAAGGGCTATT”

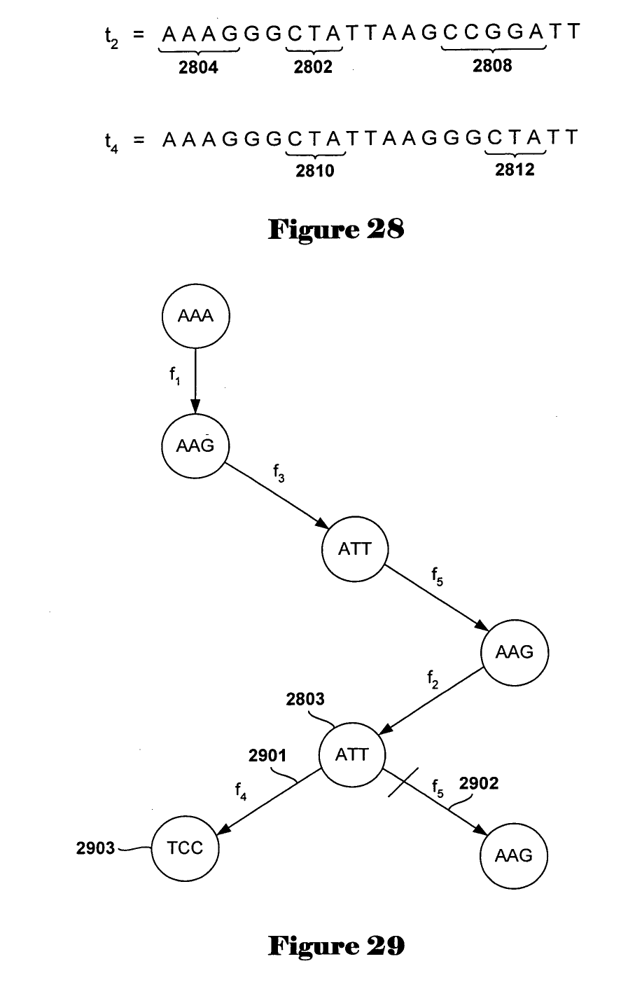

The nucleic acid sequences represented by candidate molecules t₂ and t₄ are compared with the DP of hypothetical target molecule. FIG. 28 shows the nucleic acid sequences of candidate molecules t₂ and t₄. In FIG. 28, for candidate molecule t₂, the subsequence “CTA” 2802 is located next to start(s) 2804, and subsequence “CCGGA” 2804 is located after “CTA” 2802, which compares with the decoration patterns for hypothetical target molecule, as described above with reference to FIG. 21. In FIG. 28, the sequence represented by candidate molecule t₄ is not consistent with the decoration pattern of hypothetical target molecule because the subsequence “CTA” appears twice in sequence at locations 2810 and 2812. Therefore, edge 2701 is pruned from the directed tree in FIG. 27.

FIG. 29 illustrates expanding node 2703, shown in FIG. 27, by adding edges 2901 and 2902 which coincide with edges 1904 and 1905, respectively, of the graph shown in FIG. 19. Candidate molecule t₂ is concatenated with SBH fragments f₄ and f₅ to give:

S = {t₂, t₅}
where t₂ = t₂ · f₄ = “AAAGGGCTATTAAGCCGGATTCC,”
and
t₅ = t₂ · f₅ = “AAAGGGCTATTAAGCCCGGATTAAG”

Because the length of candidate molecule t₅ (24 bases) is greater than the length(s) (23 bases), edge 2902 is pruned from the directed tree shown in FIG. 29. Candidate molecule t₂ provides the unique reconstructed sequence of hypothetical target molecule s, because candidate molecule t₂ is both SBH consistent and DP consistent with the hypothetical target molecule s.

The method described above with reference to FIGS. 18-29, illustrates employing the spectrum σₖ(s) and using the target molecule s decoration patterns to uniquely determine the sequence of a hypothetical target molecule s. In many cases introduction of the target molecule decoration pattern as additional information to complement the SBH spectrum does not serve to solve the intrinsic practical difficulties associated with obtaining stringent SBH spectra. Note that, in the example described above with reference to FIGS. 18-29, the method of the present invention employed the SBH spectrum and DP of the target molecule to reconstruct the unique nucleic acid sequence of the example target molecule. However, in actual practice, the method of the present invention alone may not be able to uniquely reconstruct the unique nucleic acid sequence of a target molecule. For example, the method the present invention can be used to reduce a large number of candidate molecules to a much smaller number of candidate molecules, such as 2, 3, 5, or 10 or more candidate molecules. As a result, the method of the present invention can be combined with other nucleic acid sequencing techniques to reconstruct the unique nucleic acid sequence of the target molecule or further reduce the small number of candidate molecules.

Reconstructing the unique nucleic acid sequence of the target molecule by combining information from decoration patterns with the experimentally determined spectrum of the target molecule may still result in ambiguous solutions. In order to bolster the information needed to reduce the number of ambiguous solutions, the method of the present invention may include an optional step of combining the information obtained from the target molecule decoration patterns and the spectrum with homologous nucleic acid sequence information of the target molecule species. Use of homologous nucleic acid sequences is predicated on the understanding that many nucleic acid molecules of all individuals of the same species are nearly identical. The homologous nucleic acid sequences are called reference sequences and are already determined for the target molecule species. Candidate molecules can be discarded based aligning each candidate molecule with a reference sequence of target molecule species. Aligning each candidate molecule includes matching pairs of the reference sequence loci with each candidate molecule loci and determining an alignment score. Methods for determining the alignment score of two nucleic acid molecules are well known in the art. (See e.g., T. F. Smith, and M. S. Waterman, “Identification of Common Molecular Subsequences,” J. of Molecular Biology, 147(1):195-197, 1981) Various candidate molecules can be discarded based on the alignment score. The method of the present invention may optionally include determination of the best alignment of a reference sequence associated with the target molecule species with the various candidate molecules already obtained from combining the spectrum and decoration pattern information, as described above with reference to FIGS. 18-29. The candidate molecule having the best sequence alignment with the resource sequence has a higher probability of coinciding with the target molecule. In another embodiment, both decoration pattern information and reference sequence information can be simultaneous used to prune branches as the directed tree is dynamically constructed, as described above with reference to FIGS. 18-29. A method for dynamically combining reference sequence information with the target molecule directed graph G(σₖ(s)) to reconstruct the sequence of a target molecule is described in I. Pe'er and R. Shamir, “Spectrum Alignment: Efficient Resequencing by Hybridization,” Proc. ISMB, pp 260-268, 2000, and is incorporated by reference.

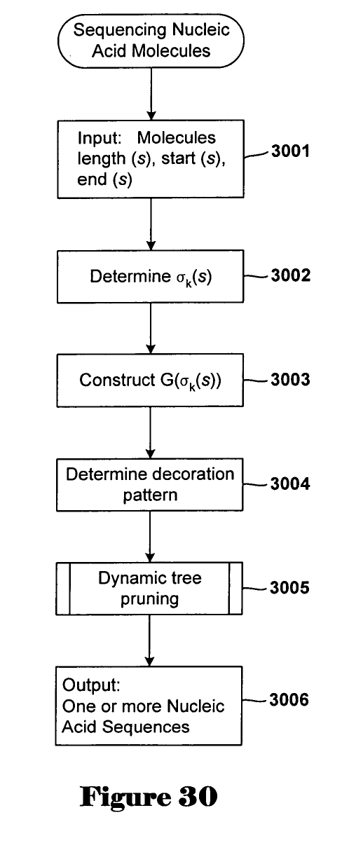

FIGS. 30-32 provide control-flow diagrams used to describe one of many possible methods for determine the sequence of a target molecule s having an unknown or partially known nucleic acid sequence. FIG. 30 is a control-flow diagram that describes the method “Sequencing Nucleic Acid Molecules.” In step 3001, the length(s), start(s), and end(s) are provided as input. Note that in alternate embodiments, start(s) and end(s) may be unknown. In step 3002, the spectrum σₖ(s) is determined, as described above with reference to FIG. 9. In step 3003, the directed graph G(σₖ(s)) is determined, as described above with reference to FIGS. 10-11. In step 3004, the decoration pattern of the target molecule s can be determined using nanopore hybridization assays, as described above with reference to FIGS. 15, 16, and 20-21. In step 3005, the routine “Dynamic Tree Pruning” is called. In step 3006, one or more candidate molecules tᵢ are output.

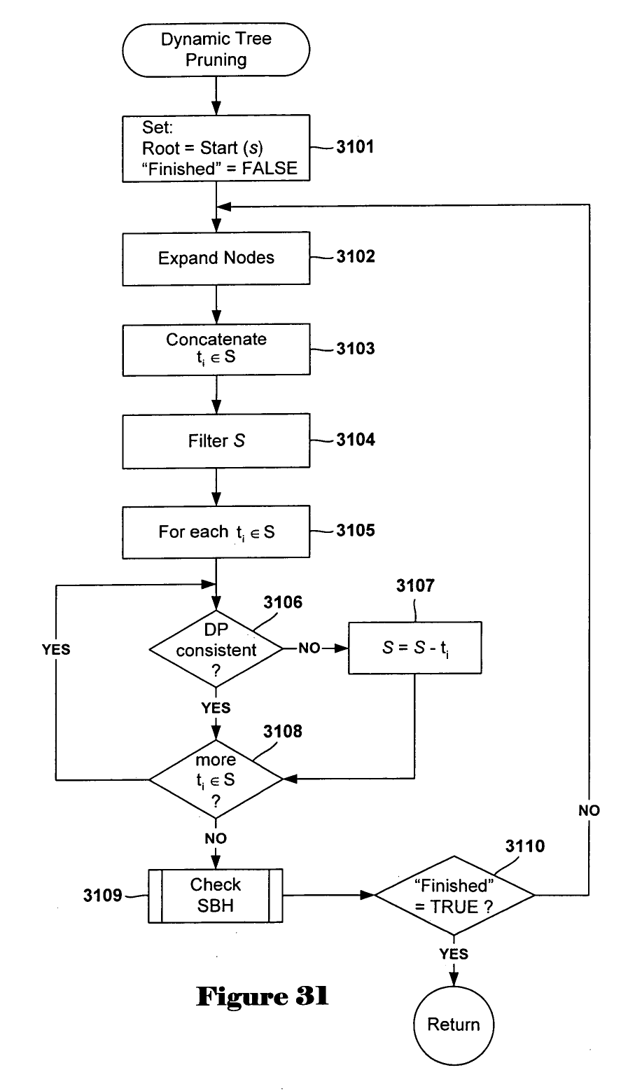

FIG. 31 is a control-flow diagram of the routine “Dynamic Tree Pruning.” In step 3101, the root of a directed tree is assigned the starting sequence given by start(s) and the Boolean variable “Finished” is assigned the value “FALSE.” In step 3102, the nodes of the directed tree are expanded, as described above with reference to FIG. 22. In step 3103, the prefix sequences of the candidate molecules tᵢ in the set S are created by concatenating sequences, as described above with reference to FIG. 23. In step 3104, the candidate molecules tᵢ is the set S are filtered to remove candidate molecules tᵢ length (tᵢ) larger than length(s), or if the tail sequence of a candidate molecule tᵢ, denoted by tail(tᵢ), is identical to end(s) and length (tᵢ) is not equal to length(s). The for-loop in step 3105 repeats steps 3106-3108, for each candidate molecule tᵢ in S. In step 3106, if a candidate molecules tᵢ is not DP consistent with the target molecule s, then in step 3107, the candidate molecule tᵢ is removed from S. In step 3108, if S is not empty, then steps 3106-3108 are repeated, otherwise control passes to step 3109. In step 3109, the routine “Check SBH” is called. In step 3110, if the Boolean variable “Finished” is not assigned the value “TRUE,” then steps 3102-3110 is repeated.

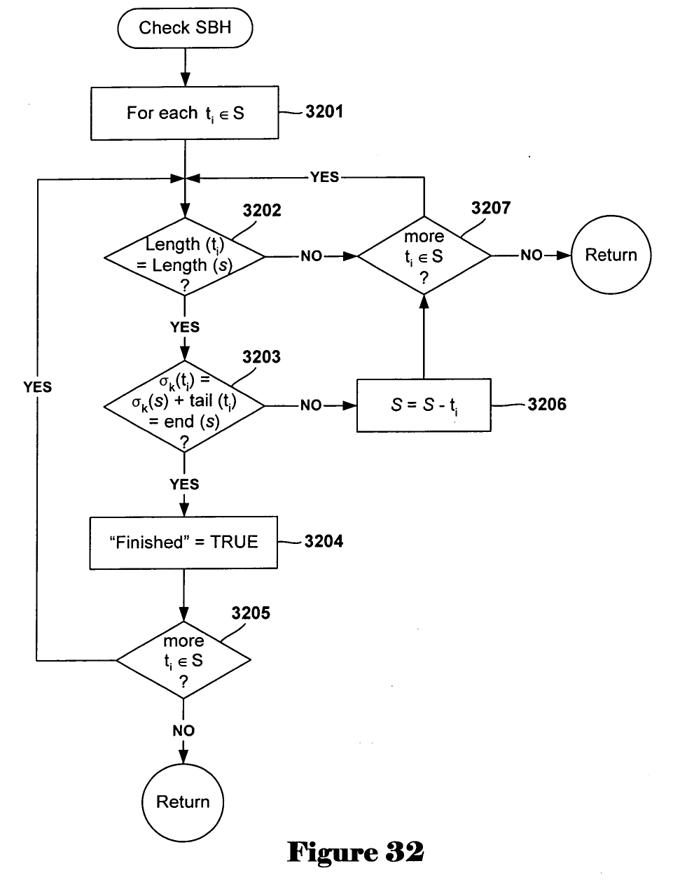

FIG. 32 is control-flow diagram of the routine “Check SBH.” The for-loop in step 3201 repeats steps 3202-3207, for each candidate molecule tᵢ in S. In step 3202, if length(tᵢ) is not identical to length(s), then control is passed step 3207. In step 3207, if S is not empty then step 3202 is repeated. In step 3202, if length(tᵢ) is identical to length(s), then control passes to step 3203. In step 3203, if spectrum of candidate molecule tᵢ is identical to the spectrum of target molecule s, and tail(tᵢ) is identical to end(s), then in step 3204, Boolean variable “Finished” is assigned the value “TRUE,” otherwise in step 3206, candidate molecule tᵢ is removed from S. In step 3205, if S is not empty, then steps 3202-3207 are repeated.

### Other Embodiments

Although the present invention has been described in terms of a particular embodiment, it is not intended that the invention be limited to this embodiment. Modification within the spirit of this invention will be apparent to those skilled in the art.

In an alternate embodiment, the probes may be zinc-finger proteins designed to bind to specific nucleic acid sequences of the target molecule. In an alternate embodiment, the oligonucleotide probes used in the nanopore assay may be comprised of different chemical moieties that generate unique and identifiable events in the current-based image decoration patterns. In alternate embodiments, the starting and ending subsequences of the target molecule need not be known before hand. In an alternate embodiment, determining the spectrum can be modified by designing a smallest set of probes that can be used as described in A. M. Frieze, F. P. Preparata, and E. Upfal, “Optimal Reconstruction of a Sequence from its Probes,” J. Comput. Biology, (6) 361-368, 1999, and is incorporated by reference. The Preparata et al. SBH method assumes knowledge of the prefix sequence of the target molecule and includes a deterministic oligonucleotide probe design that employs universal bases that bind to any of the four bases. In an alternate embodiment, determination of the spetrum can be modified according to the method described in E. Halperin, S. Halperin, T. Hartman, and R. Shamir, “Handling Long Targets and Errors in Sequencing by Hybridization,” J. Comput. Biology, (10) 483-497, 2003 and is incorporated by reference. Shamir et al. employs a randomized microarray oligonucleotide probe design that is noise resistant. In other words, randomized oligonucleotide probe designs have little effect on the length of constructible sequences and can be used to determine the spectrum of the target molecule. In alternate embodiments, other analytical techniques can be substituted for nanopore technology to determine the decoration pattern of the nucleic acid molecule. For example, electron microscopy can be used to image the probe/target-molecule complex. Electron microscopes focus a beam of highly energetic electrons to examine objects on a micrometer scale. Heavy metal atoms bound to each probe are used to image the decoration pattern of the probe/target-molecule complex bound to the surface of a substrate. In another example of an analytical technique, the absorbed probe/target-molecule complex is scanned using scanning tunneling microscopy. The scanning tunneling microscope raster scans the surface having the bound probe/target-molecule complex. Scanning tunneling microscopy is capable of detecting tiny, atom-scale variations in the height of the substrate surface to image the probe/target-molecule complex. The result is a detailed image of the surface having a raised region showing the absorbed probe/target-molecule complex to the substrate surface. In another example of an analytical technique, fluorescent or chemiluminescent labels are bound to each probe. The probe/target-molecule complex is placed on a slide and exposed to electromagnetic radiation of an appropriate frequency to produce emissions revealing the decoration pattern of the nucleic acid molecule. In another example of an analytical technique, radiometric reading can be used to image the decoration pattern of the nucleic acid molecule by binding radioisotope labels to each probe. The radioisotope labels emit a detectable microwave signal from the absorbed probe/target-molecule complex to distinguish different probes.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purposes of illustration and description. They are not intended to be exhaustive or to limit the invention to the precise forms disclosed. Obviously, many modifications and variations are possible in view of the above teachings. The embodiments are shown and described in order to explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

What is claimed is:

1. A method for sequencing a target molecule, the method comprising:
determining a spectrum of the target molecule;
determining a decoration pattern of the target molecule by physical methods; and
determining one or more candidate molecule sequences that are consistent with the spectrum and the decoration pattern of the target molecule.

2. The method of claim 1 wherein determining one or more candidate molecule sequences that are consistent with the spectrum and the decoration pattern of the target molecule further comprises:
constructing a directed graph based on the spectrum of the target molecule;
progressively generating candidate molecules having known nucleic acid sequences by traversing paths in the directed graph; and
during progressive generation of candidate molecules, discarding candidate molecules based on inconsistencies between the candidate molecule nucleic acid sequences and the target molecule decoration pattern.

3. The method of claim 2 wherein the directed graph is a subgraph of a directed de Bruijn graph composed of nodes that correspond to all nucleic acid (k−1)-mers and edges that identify k-mer subsequences of the target molecule that overlap the prefix and suffix bases of each pair of nodes.

4. The method of claim 2 wherein discarding candidate molecules further comprises discarding candidate molecules having spectra different from the target molecule spectrum.

5. The method of claim 2 wherein discarding candidate molecules further comprises discarding candidate molecules having a length in excess of the target molecule length.

6. The method of claim 2 wherein discarding candidate molecules further comprises discarding candidate molecules based on aligning each candidate molecule with a reference sequence having a known nucleic acid sequence.

7. The method of claim 6 wherein discarding candidate molecules further comprises discarding candidate molecules that are not homologous to the reference sequence.

8. The method of claim 1 wherein determining the spectrum of the target molecule further comprises conducting a microarray-based hybridization assay.

9. The method of claim 1 wherein the spectrum further comprises k-mer subsequences of the target molecule.

10. The method of claim 1 wherein determining the decoration pattern of the target molecule further comprises determining locations of probe/molecule complexes by binding one or more probes to complementary subsequences of the target molecule.

11. The method of claim 10 wherein the one or more probes further comprises either oligonucleotide probes or zinc finger proteins.

12. The method of claim 10 wherein determining locations of probe/molecule complexes further comprises identifying approximate locations of probe/nucleic acid complexes using electrical current based nanopore hybridization assays.

13. The method of claim 10 wherein determining locations of probe/molecule complexes further comprises imaging probe/target-molecule complexes.

14. The method of claim 13 wherein imaging the probe/nucleic acid complex further comprise identifying approximate locations of probe/nucleic acid complexes based on scanning tunneling microscopy.

15. The method of claim 13 wherein imaging the probe/nucleic acid complex further comprises identifying approximate locations of probe/nucleic acid complexes based on electron microscopy.

16. The method of claim 13 wherein imaging the probe/nucleic acid complex further comprises identifying approximate locations of probe/nucleic acid complexes based on radiometric reading.

17. Transferring results produced by a data processing program employing the method of claim 1 stored in a computer-readable medium to an intercommunicating entity.

18. Transferring results produced by a data processing program employing the method of claim 1 to an intercommunicating entity via electronic signals.

19. A computer program including an implementation of the method of claim 1 stored in a computer-readable medium.

20. A method comprising forwarding data produced by using the method of claim 1.

21. A method comprising receiving data produced by using the method of claim 1.

22. A system for sequencing a target molecule, the system comprising:
a computer processor;
one or more memory components that store microarray data;
one or more memory components that store image decoration pattern data; and
a stored program executed by the computer processor that determines a spectrum of the target molecule, determines a decoration pattern of the target molecule by physical methods, and determines one or more candidate molecule sequences that are consistent with the spectrum and decoration pattern of the target molecule.

23. The system of claim 22 wherein determines one or more candidate molecule sequences that are consistent with the spectrum and decoration pattern of the target molecule further comprises:
constructs a directed graph based on the spectrum of the target molecule;
progressively generates candidate molecules having known nucleic acid sequences by traversing paths in the directed graph; and
during progressive generation of candidate molecules, discards candidate molecules based on inconsistencies between the candidate molecule nucleic acid sequences and the target molecule decoration pattern.

24. The system of claim 22 wherein the directed graph is a subgraph of a directed de Bruijn graph composed of nodes that correspond to all nucleic acid (k−1)-mers and edges that identify k-mer subsequences of the target molecule that overlap the prefix and suffix bases of each pair of nodes.

25. The system of claim 22 wherein discards candidate molecules further comprises discards candidate molecules having spectra different from the target molecule spectrum.

26. The system of claim 22 wherein discards candidate molecules further comprises discards candidate molecules having a length in excess of the target molecule length.

27. The system of claim 22 wherein discards candidate molecules further comprises discards candidate molecules based on aligning each candidate molecule with a reference sequence having a known nucleic acid sequence.


SEQUENCE LISTING (13 sequences)

SEQ ID NO: 1 - DNA, 10 bp, Artificial
  Hypothetical sequence used to validate computational method
aagccggatt

SEQ ID NO: 2 - DNA, 10 bp, Artificial
  Hypothetical sequence used to validate a computational method
aagggctatt

SEQ ID NO: 3 - DNA, 11 bp, Artificial
  Hypothetical sequence used to validate a computational method
aaagccggatt

SEQ ID NO: 4 - DNA, 11 bp, Artificial
  Hypothetical sequence used to validate a computational method
aaagggctatt

SEQ ID NO: 5 - DNA, 14 bp, Artificial
  Hypothetical sequence used to validate a computational method
aaagggctattaag

SEQ ID NO: 6 - DNA, 13 bp, Artificial
  Hypothetical sequence used validate a computational method
aaagggctattcc

SEQ ID NO: 7 - DNA, 21 bp, Artificial
  Hypothetical sequence used to validate a computation method
aaagggctattaagccggatt

SEQ ID NO: 8 - DNA, 21 bp, Artificial
  Hypothetical sequence used to validate a computational method
aaagggctattaagggctatt

SEQ ID NO: 9 - DNA, 23 bp, Artificial
  Hypothetical sequence used to validate a computational method
aaagggctattaagccggattcc

SEQ ID NO: 10 - DNA, 24 bp, Artificial
  Hypothetical sequence used to validate a computational method
aaagggctattaagccggattaag

SEQ ID NO: 11 - DNA, 23 bp, Artificial
  Hypothetical sequence used to validate a computational method
aaagccggattaagggctattcc

SEQ ID NO: 12 - DNA, 39 bp, Artificial
  Hypothetical sequence used validate a computational method
acctgggaacctgtacccttagcttaaggctctgatccg

SEQ ID NO: 13 - DNA, 22 bp, Artificial
  Hypothetical sequence used to validate a computational method
cccttagcttaaggctctgatc